(19) United States
(12) Patent Application Publication
(10) Pub. No.: US 2026/0124519 A1
(43) Pub. Date: May 7, 2026

(54) SYSTEM AND METHOD OF SPORTS TRAINING USING MACHINE LEARNING AND GENERATIVE AI

(71) Applicant: SportifAI LLC, San Diego, CA (US)

(72) Inventors: Wei Shi, Cambridge, MA (US); Yan Hui, San Diego, CA (US)

(73) Assignee: SportifAI LLC, San Diego, CA (US)

(21) Appl. No.: 19/377,416

(22) Filed: Nov. 3, 2025

Related U.S. Application Data
(60) Provisional application No. 63/716,172, filed on Nov. 4, 2024.

(51) Int. Cl. A63B 71/06; A63B 24/00; G06V 10/62; G06V 10/774; G06V 10/82; G06V 20/40; G06V 40/20

(52) U.S. Cl. CPC A63B 71/0622; A63B 24/0006; A63B 24/0062; G06V 10/62; G06V 10/774; G06V 20/46; G06V 40/23; A63B 2220/05; A63B 2220/806; G06V 10/82

(57) ABSTRACT

A system and method are disclosed for multimodal training and inference of an artificial intelligence (AI) model for analyzing and improving athletic performance. Player videos are processed through pose estimation and key-feature extraction to generate structured skeletal and temporal data, which are aligned with human commentary through text tokenization and multimodal embedding. A transformer-based or large language model (LLM) architecture is trained and fine-tuned using these multimodal inputs to learn relationships between motion patterns and coaching semantics. During inference, new player data and optional human input are projected into a shared latent space to produce textual feedback and visual reconstructions showing improved technique execution. A user interface enables personalized comparison, skill progression analysis, and visualization of model-generated corrections. The system supports cross-modal reasoning, individualized fine-tuning, and real-time feedback across multiple sports and training contexts.

### PRIORITY

This application claims the benefit of priority to U.S. Provisional Patent Application Ser. No. 63/716,172 filed Nov. 4, 2024, and entitled “SYSTEM AND METHOD OF SPORTS TRAINING USING MACHINE LEARNING AND GENERATIVE AI”, incorporated by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TECHNICAL FIELD

This disclosure relates generally to the field of sports training. Specifically, systems, apparatus, and methods for using machine learning and generative artificial intelligence (AI) in sports training.

### DESCRIPTION OF RELATED TECHNOLOGY

Technique may not be black and white in sports; there's not always a simple “right” or “wrong” technique, instead, techniques may fall along a spectrum. Techniques are also highly personalized due to differences in physique of players.

Traditionally, players learn and develop techniques by attempting to replicate techniques that their coaches teach them. Conventional tools for coaches to demonstrate techniques are based on video/image overlays and/or side-by-side visualizations. Exotic solutions may physically place markers on key joints of the human body for joint tracking; cameras can capture and trace movement using these markers, allowing coaches to make corrections to the player's technique.

Conventional solutions have struggled to address the spectrum of techniques. Many of these tools have been ineffective due to the highly complicated biomechanics involved in sports techniques—techniques that work for one body type may not work for a different body type, etc.

### BRIEF DESCRIPTION OF THE DRAWINGS

FIG. 1 is a logical block diagram of a system architecture for a training phase of an artificial intelligence (AI) model.

FIG. 2 is a logical block diagram of a system architecture for an inference phase of an artificial intelligence (AI) model.

FIG. 3 is a logical block diagram of generalized training model.

FIG. 4 is a logical flow diagram of a first method for model training.

FIG. 5 is a logical flow diagram of a second method for model training.

FIG. 6 is a logical flow diagram of a third method for model training.

FIG. 7 is a logical flow diagram of a fourth method for model training.

FIG. 8 is a logical flow diagram of a fifth method for model training.

FIG. 9 is a logical flow diagram of a sixth method for model training.

FIG. 10 is a logical block diagram of singleton model training.

FIG. 11 is a graphical representation of an arrangement of training data sets for singleton training.

FIG. 12 is a logical block diagram of duo model training.

FIG. 13 is a graphical representation of a first arrangement of training data sets for duo training.

FIG. 14 is a graphical representation of other arrangements of training data sets for duo training.

FIG. 15 is a logical block diagram of one detailed system architecture for model training and inference in a cloud environment.

FIG. 16 is a logical block diagram of one method for model training based on pre-training of a transformer model.

FIG. 17 is a logical block diagram of one implementation of the inference phase for a trained model.

FIG. 18 is a logical block diagram of one method for fine tuning a pre-trained LLM.

FIG. 19 is a logical block diagram of one implementation of the inference phase for a model that is fined tuned from a pre-trained LLM.

FIG. 20 is a graphical representation of a user interface for a tennis training application.

FIG. 21 is a graphical representation of: pose estimation and key feature annotation for tennis training of backhand techniques.

FIG. 22 is a graphical representation of key features extracted from pose estimation after segmentation of the time-series results for tennis training of backhand techniques.

### DETAILED DESCRIPTION

In the following detailed description, reference is made to the accompanying drawings. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without departing from the spirit or scope of the present disclosure. It should be noted that any discussion regarding “one embodiment”, “an embodiment”, “an exemplary embodiment”, and the like indicate that the embodiment described may include a particular feature, structure, or characteristic, and that such feature, structure, or characteristic may not necessarily be included in every embodiment. In addition, references to the foregoing do not necessarily comprise a reference to the same embodiment. Finally, irrespective of whether it is explicitly described, one of ordinary skill in the art would readily appreciate that each of the features, structures, or characteristics of the given embodiments may be utilized in connection or combination with those of any other embodiment discussed herein.

Various operations may be described as multiple discrete actions or operations in turn, in a manner that is most helpful in understanding the claimed subject matter. However, the order of description should not be construed as to imply that these operations are necessarily order dependent. The described operations may be performed in a different order than the described embodiments. Various additional operations may be performed and/or described operations may be omitted in additional embodiments.

### 1 Generative Artificial Intelligence for Sports Training

Recent breakthroughs in AI technology (e.g., Generative AI (GenAI), foundation models and large language models (LLMs), large vision models (LVMs) and large multimodal models (LMMs)) are creating waves of new innovations in many industries. Sports and sports-related businesses are a trillion-dollar industry and have strong influence on health, lifestyle, and/or entertainment. Injecting GenAI, LLMs, LVMs, LMMs into sports will open up many new opportunities for the sports industry and people's lifestyle.

Various aspects of the present disclosure apply artificial intelligence (AI) models and large multimodal models to sports and sports training. Illustrative embodiments are described in the context of tennis, tennis training, and coaching. More broadly however, the same methodology, system, architecture, algorithm and implementations can be extended to other sports; this may include, without limitation, racket sports (such as Paddleball, Pickleball, etc.), ball sports (such as baseball, basketball, football, soccer), and/or any other sport having objective movement-based techniques (e.g., golf, fencing, gymnastics, swimming, ice-skating, acrobatics, etc.)

As a brief aside, AI models may operate in two distinct phases: a training phase and an inference phase. In the training phase, a data set is used to train the AI model (e.g., neural networks, multi-modal generative AI models, etc.). Training data may include both the player's performance data (e.g., selected videos/images and/or annotated videos/images of the player performing a technique) as well as coaching data (e.g., (e.g., voice/text inputs) that explain the associated video/images, statistics, predefined or custom defined key features, plots that are also associated with the video/images, etc.).

Once the model training performs to a threshold accuracy (e.g., predicting coaching data based on player performance data), then the training phase is complete and the model may be used in its inference phase.

During the inference phase, its training is applied to sports training. Specifically, it generates coaching output to teach different techniques for the sport. Coaching outputs may widely vary; for example, output may provide detailed instruction on basic techniques, specific tips for complex techniques, and/or holistic strategies/tactics for coaching gameplay.

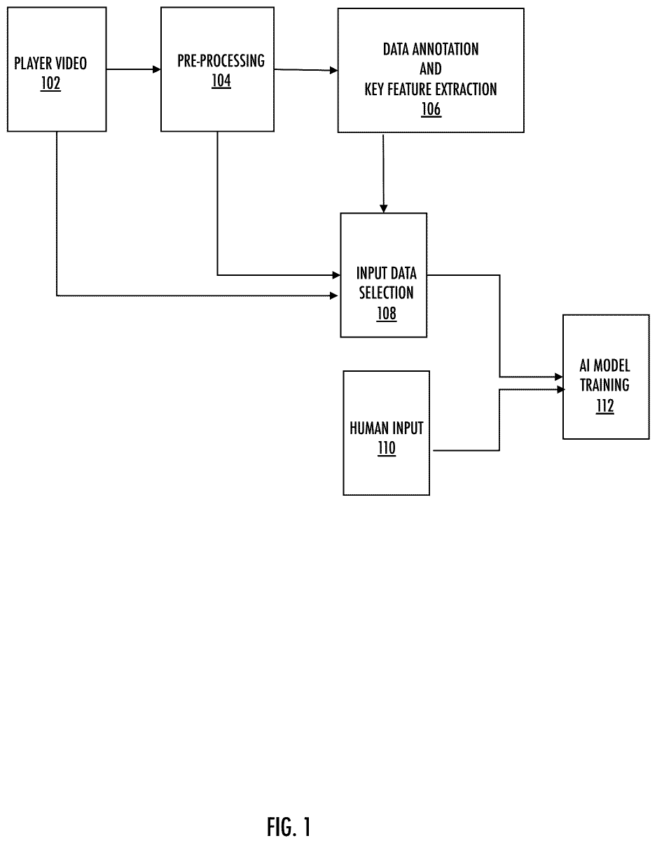

FIG. 1 is a logical block diagram of a system architecture for a training phase of an artificial intelligence (AI) model 112. The system comprises a input (e.g., player video 102), a pre-processing module 104, a data annotation and key feature extraction module 106, an input data selection module 108, a human input module 110, and the AI model training module 112.

The player video database 102 comprises a curated repository of digital recordings that depict one or more athletes performing defined physical techniques. Each recording is stored as a digital file containing visual information, and in certain embodiments audio or depth information captured from multiple cameras or sensors. The repository may include multiple categories of techniques, such as forehand, backhand, or service motions, and may further include variations of each category recorded under differing environmental conditions. Each recording is indexed by metadata identifying the player, technique type, capture date, and session parameters. The player video 102 provides the foundational data from which motion features, performance characteristics, and contextual relationships are derived during model training.

The pre-processing module 104 is implemented as executable logic or hardware circuitry configured to standardize the raw video data retrieved from the player video database 102. The module validates that each digital file conforms to predetermined input criteria including resolution, frame rate, duration, and encoding format. When a file does not satisfy these criteria, the module reformats the file by scaling frames, adjusting temporal spacing, or trimming excess duration. The module also generates metadata descriptors such as timestamps, camera orientation, or sensor identifiers and associates these with the corresponding video. In multi-camera implementations, the module synchronizes temporal indices across streams to ensure alignment. The pre-processing module 104 outputs standardized media and metadata files that enable consistent downstream annotation and feature extraction.

The data annotation and key feature extraction module 106 receives the standardized output from the pre-processing module 104 and identifies salient spatial and temporal features within each frame sequence. The module executes computer-vision algorithms such as pose-estimation or motion-tracking networks to detect limb joints, tool positions, or motion vectors. Detected features are encoded into coordinate arrays or structured tensors representing body-segment positions, angular velocities, or movement trajectories. Annotation logic associates these extracted features with semantic labels that describe the observed technique segment. The resulting dataset includes frame-indexed annotations and feature matrices that represent technical motion details required for AI training. The data annotation and key feature extraction module 106 thus converts video imagery into structured feature data suitable for computational learning.

The input data selection module 108 manages organization of annotated and pre-processed data for training. The module aggregates data objects from previous modules (player video database 102, pre-processing module 104, data annotation and key feature extraction module 106, etc.) and verifies their completeness and category consistency. It groups related elements—such as elbow, foot, and hip motion features—that correspond to the same technique instance. The selection logic filters out inconsistent or redundant entries and aligns grouped datasets for coherent model ingestion. When additional player data become available, the module integrates new subsets into the existing repository while maintaining category boundaries. The input data selection module 108 therefore ensures that the AI model receives a balanced and contextually coherent dataset during training.

The human input module 110 captures coaching data produced by qualified experts and associates these data with the corresponding video instances from the player video database 102. Human input may be recorded as textual annotations, voice transcripts, or structured tags identifying specific performance aspects such as timing, alignment, or technique efficiency. The module digitizes the coaching content and, when applicable, encodes it into numerical embeddings or symbolic representations. Each commentary item is indexed to the relevant frames or features produced by data annotation and key feature extraction module 106, enabling precise correlation between human observation and visual evidence. The human input module 110 thus provides the semantic layer that defines interpretive meaning for the machine-learning process.

The AI model training module 112 integrates the encoded outputs from the input data selection module 108 and the human input module 110 to perform model training. The module executes a training engine that applies optimization algorithms to learn mappings between visual feature inputs and corresponding coaching commentary outputs. Training data are divided into batches, and during each iteration the engine computes a loss function representing divergence between model predictions and target commentary. Model parameters are adjusted through gradient-based optimization until convergence is reached. Fine-tuning procedures may be performed on specialized subsets of data to refine the model for specific technique categories. The AI model training module 112 produces a set of stored weights defining a trained model that transforms input features derived from new player videos into corresponding coaching feedback.

Collectively, the aforementioned components operate as a structured pipeline that transforms raw video of athletic performance and expert commentary into a trained artificial-intelligence model. Each component performs a defined computational role that contributes to standardized data preparation, semantic correlation, and supervised learning. The resulting trained model is configured for deployment in subsequent inference phases to generate technique evaluations and coaching guidance from new athlete recordings.

During training operation, curated data sets from the player video database 102 are first processed by the pre-processing module 104. The module verifies that each digital file satisfies predefined technical criteria and reformats any non-conforming data through scaling, cropping, or temporal alignment. Derived metadata—such as timestamps, camera orientation, or technique labels—is generated to supplement each standardized file. Where multiple sensors capture synchronous modalities, the module performs temporal registration so that frames are aligned across devices. The output of the pre-processing module 104 comprises a standardized media stream and an associated metadata record that serve as the input domain for subsequent annotation and feature extraction.

In certain implementations, the standardized data are encoded into a numerical representation acceptable to the AI model training module 112. For example, the data annotation and key feature extraction module 106 applies computer-vision algorithms to identify spatial and temporal keypoints and derives coordinate arrays that describe limb positions, angular relationships, and velocity profiles. These values are assembled into feature tensors that are normalized for model input. Annotations are stored as structured data objects referencing corresponding frame indices and player identifiers. Similarly, the human input module 110 encodes coaching commentary into token embeddings or numerical vectors using a language model encoder. The combined output therefore comprises aligned visual-feature tensors and semantic embeddings formatted for ingestion by the AI model training module 112.

The AI model training module 112 receives the encoded feature tensors and corresponding commentary embeddings to perform model training. A training engine executes iterative optimization steps that update internal model weights based on a loss function measuring deviation between predicted and reference commentary outputs. During fine-tuning, selected subsets of annotated techniques are applied to refine weights or adjust hyperparameters. This may include modifying learning rates, network depth, or regularization terms to improve convergence while retaining prior knowledge. The trained model parameters are stored in non-volatile memory for later inference.

The trained model 112 is subsequently applied to process user data sets. A new user recording is received by the player video database 102 and undergoes pre-processing (pre-processing module 104) and feature extraction (data annotation and key feature extraction module 106) as in the training sequence. The encoded features are input to the trained model 112, which generates predicted coaching outputs in the form of structured feedback. Such feedback may include positional metrics, motion scores, or symbolic instructions. A presentation interface converts the model output into textual or audible instructions for the athlete. Session data may be archived for trend analysis or performance tracking.

User data sets processed during deployment may be recycled for continued model improvement. Each new combination of player video, features, and human input, forms an additional training instance appended to the repository. The input data selection module 108 may select/aggregate new subsets for incremental retraining. The AI model training module 112 executes scheduled or continuous learning cycles that update the stored weights while maintaining stability of previously acquired mappings. The operation produces an updated model whose parameters reflect the cumulative dataset.

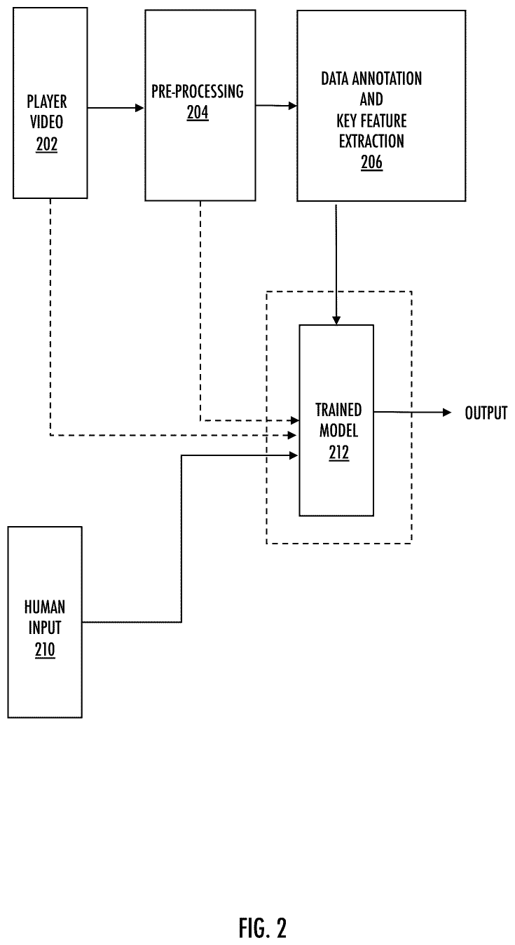

FIG. 2 is a logical block diagram of a system architecture for an inference phase of an artificial intelligence (AI) model 212. The system includes an input player video 202, a pre-processing module 204, a data annotation and key feature extraction module 206, a human input module 210, and a trained AI model 212. The components implement similar functionality during the inference phase as compared to training phase, similar functionality is not discussed for the sake of brevity—however, inference specific actions are discussed in greater detail below.

During the inference phase, the player video 202 comprises captured image data depicting a subject athlete performing a designated technique or movement sequence. The recording may be acquired through one or more imaging devices, such as fixed-position cameras, handheld cameras, mobile devices, or sensor-equipped training equipment. In certain embodiments, the recording includes synchronized depth data, inertial-measurement-unit readings, or environmental audio. Each video file includes time-stamped frame data that preserve the chronological progression of motion. The file may be formatted in any digital container compatible with downstream modules, such as MP4, AVI, or proprietary encodings. Metadata identifying the subject, session date, and capture context may be appended to or embedded within the file header. The player video 202 thus functions as the primary observation dataset from which all subsequent computational analyses in the inference system originate.

The pre-processing module 204 receives the captured player video 202 and standardizes the data for compatibility with the inference pipeline. The module may be implemented as executable software code, firmware instructions, or dedicated digital-signal-processing circuitry. The module verifies that each video file conforms to defined technical specifications for frame rate, resolution, color depth, and encoding format. Files that do not meet those specifications are transformed by scaling, cropping, re-encoding, or time-base correction. In some configurations, the module performs background subtraction, noise suppression, or temporal alignment of multi-camera feeds. The module may also generate auxiliary metadata including camera calibration parameters, sensor identifiers, and video length. The resulting output comprises a normalized data structure that ensures predictable performance of subsequent feature-extraction operations. The pre-processing module 204 thereby ensures that the captured player video 202 conforms to uniform input conditions for all inference data.

The data annotation and key feature extraction module 206 operates on the standardized video data generated by pre-processing module 204 to derive structured quantitative features. The module may include one or more computer-vision algorithms configured to detect body landmarks, limb trajectories, or object interactions within the video frames. In one implementation, a pose-estimation network extracts skeletal key points and maps them to a coordinate space defined by camera calibration parameters. Temporal tracking logic associates successive key points to form motion trajectories and calculates derivative quantities such as velocity, angular displacement, and acceleration. The module assigns semantic labels identifying technique phases or sub-movements to each trajectory segment. The resulting annotated dataset includes frame indices, feature vectors, and motion descriptors that together represent the athlete's movement pattern. The data annotation and key feature extraction module 206 thus transforms visual media into a numerical representation suitable for machine inference.

The human input module 210 provides an interface for receiving and processing coaching commentary related to the same performance captured in the player video 202. The module may capture live voice input through a microphone or import written commentary supplied after review of the recorded video. Voice input is digitized and optionally transcribed into text using speech-recognition software. Text input may be entered directly through a graphical interface or imported from an external file. The commentary may include evaluative statements, tactical observations, or corrective guidance. Each comment is indexed to a corresponding time interval or annotated feature generated by module 206. The human input module 210 may encode the text or transcribed speech into numerical embeddings using a language-model encoder so that semantic meaning can be incorporated into model inference. The module outputs structured commentary data aligned temporally and semantically with the video features, allowing the trained AI model 212 to consider human perspective during analysis.

The trained AI model 212 is a computational model previously generated during the training phase and configured for inference using fixed weights and parameters. The model may comprise one or more neural-network architectures or other statistical learning structures implemented in software or hardware accelerators. The model receives as input the feature tensors produced by the data annotation and key feature extraction module 206 (the player video 202 and/or any pre-processing metadata) and, when available, the encoded commentary vectors produced by the human input module 210. The model executes an inference process that computes output vectors corresponding to performance metrics, detected technique deviations, or corrective recommendations. The inference engine may be deployed in various computing environments including cloud platforms, on-premise servers, mobile devices, or embedded systems integrated into sports equipment. In distributed deployments, preprocessing and feature extraction may occur locally while inference is performed remotely via a secure communication interface. The trained AI model 212 thereby serves as the operational evaluation engine that transforms observed performance and optional human commentary into structured analytical output.

Collectively, the aforementioned system of FIG. 2 forms an inference system that receives raw athlete performance data, processes the data into structured representations, optionally integrates expert commentary, and applies a trained model to generate feedback outputs. The system produces synthesized commentary describing detected problems, technique corrections, personalized training programs, injury-prevention recommendations, and individualized coaching guidance. The resulting outputs may be displayed, transmitted, or stored for subsequent analysis. The inference architecture thereby extends the functionality of the trained AI model 212 into real-time and/or offline performance evaluation and feedback generation.

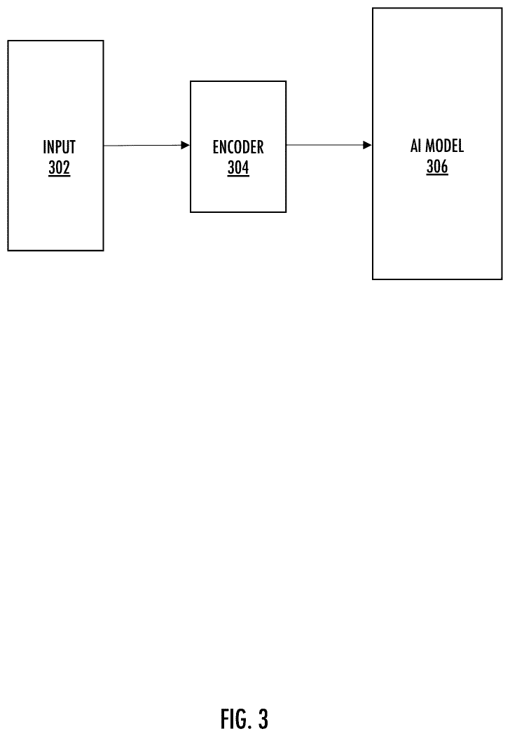

FIG. 3 is a logical block diagram of a generalized training model. The system includes an input data structure 302, an encoder 304, and an AI model 306. The input data structure 302 may comprise multiple forms of data associated with athletic performance and instruction, including raw or pre-processed video, extracted key features, time-series parameters, and human-provided commentary. The encoder 304 transforms this heterogeneous input into numerical embedding vectors that occupy positions within a high-dimensional latent space suitable for machine learning. The AI model 306 consumes these embedding vectors to perform supervised, unsupervised, or multimodal learning operations depending on the selected architecture. In one configuration, the AI model 306 is a multimodal network combining a Large Language Model (LLM) and a Large Vision Model (LVM) to correlate linguistic and visual representations of technique. More generally, FIG. 3 defines a generalized training architecture capable of receiving diverse data modalities, encoding them into unified representations, and learning parameterized mappings that support downstream inference and fine-tuning operations.

The input data structure 302 may be received via one or more data interfaces configured to receive training data sets used to construct or refine the AI model 306. The input data structure 302 may include unprocessed images or videos depicting athletes performing techniques, pre-processed or pose-estimated media, extracted numerical features, or other quantitative records such as joint-angle series, motion trajectories, or acceleration vectors. The input data structure 302 may further include textual or spoken commentary generated by human coaches, which may be transcribed or tokenized for integration with other modalities. In certain embodiments, the input data structure 302 aggregates heterogeneous data sources—visual, linguistic, and numerical—into a unified dataset indexed by time, subject identity, or training category. Each record is assigned a label or identifier defining its relevance to particular model objectives. The input data structure 302 therefore establishes the comprehensive data domain from which the encoder 304 derives embedded feature representations for training.

The encoder 304 transforms the heterogeneous data received from the input data structure 302 into numerical vectors representing the semantic and structural content of each datum. Each resulting embedding vector is a fixed-length or variable-length array whose values encode the statistical relationships among input features within a high-dimensional latent space. For visual data, the encoder 304 may employ convolutional or transformer-based layers to extract spatial and temporal patterns. For linguistic or numerical data, the encoder may utilize token embeddings or feature projection layers to capture contextual meaning or parametric relationships. The encoder 304 maps input items that are semantically or functionally similar to neighboring regions of the embedding space, enabling the AI model 306 to evaluate multimodal correspondences between movement patterns and linguistic instructions. The encoder 304 thus provides the numerical encoding that translates heterogeneous input data to the native space of the learning algorithms of the AI model 306.

The AI model 306 comprises a machine-learning network that receives the embedding vectors from the encoder 304 and computes predictive or generative outputs. In one embodiment, the AI model 306 is implemented as a neural-network architecture configured for either supervised or unsupervised learning. The architecture may include convolutional, recurrent, or transformer layers, and may incorporate attention mechanisms or windowed-context encoders to manage temporal and spatial dependencies. In multimodal configurations, the AI model 306 integrates a Large Language Model (LLM) component with a Large Vision Model (LVM) component and, where appropriate, a time-series model to handle sequential sensor data. The LLM component processes textual or spoken commentary embeddings to interpret linguistic meaning, while the LVM component processes visual embeddings representing motion or pose information. Parameters learned during training define the joint latent representations linking these modalities. As network architectures evolve, more advanced or specialized models may be substituted without altering the system's functional relationships. The AI model 306 thereby performs the core parameter optimization process that establishes correspondence between observed performance data and descriptive coaching semantics.

In some embodiments, the AI model 306 may additionally fine-tune and/or incorporate retrieval augmented generation (RAG) operation. Here, “fine-tuning” uses subsets of previously trained data or newly curated datasets to adjust specific parameters of the AI model 306. Such data may correspond to new sports domains, specialized movements, or recently collected examples. Fine-tuning may occur periodically as additional player videos or annotations become available, allowing the AI model 306 to maintain accuracy across expanding contexts. “RAG” operation introduces new curated inputs—such as video, imagery, or human commentary—as prompts to the trained model. The model generates intermediate outputs that are stored and reintroduced alongside new prompts to iteratively refine accuracy. In one embodiment, RAG operations are applied to a pre-trained LLM or multimodal model not originally trained on domain-specific data, thereby adapting general knowledge to sport-specific use cases. Both fine-tuning and RAG employ the same encoder 304 and input data structure 302 mechanisms described above to structure new data for re-training or augmentation. These iterative processes ensure that the generalized training model remains current and context-relevant for specialized performance-instruction applications.

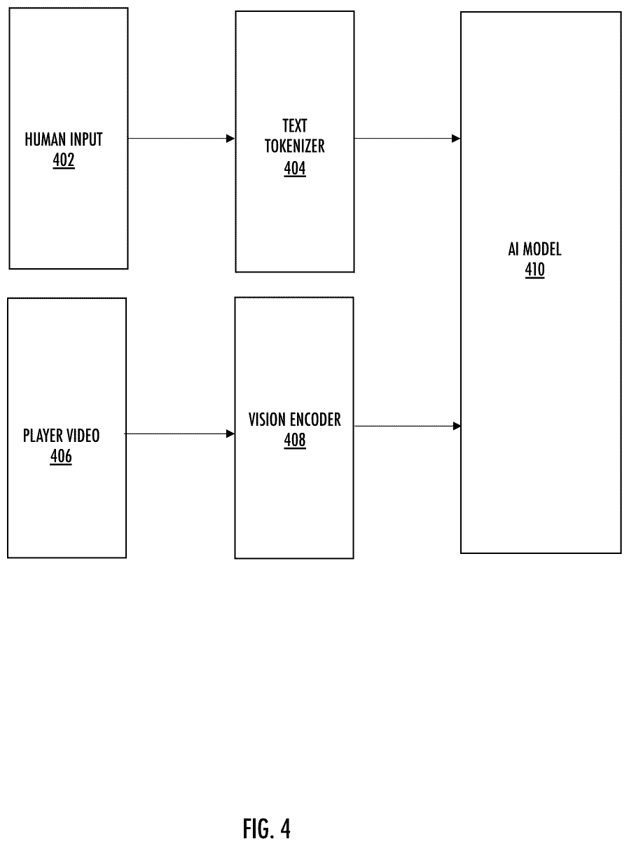

FIG. 4 is a logical flow diagram of a first method for model training. FIG. 4 represents one specific implementation of the generalized architecture described in connection with FIG. 3 and employs the data structures and encoders previously discussed (see e.g., FIG. 1-3). The method incorporates a human input 402, a text tokenizer 404, a player video 406, a vision encoder 408, and an AI model (410). Here, the human input 402 and player video 406 provide linguistic and visual modalities, respectively. The text tokenizer 404 and vision encoder 408 generate corresponding embeddings, and the AI model 410 receives these embeddings for multimodal training. Collectively, these components illustrate how domain-specific data are combined in a unified training workflow for producing a multimodal model capable of generating performance-based instructional outputs.

The human input 402 and text tokenizer handle the linguistic portion of the training data and corresponds functionally to the human-input sources and text tokenizers previously discussed elsewhere. In this embodiment, the human input is applied to generate training text or voice descriptions that directly accompany visual examples. The content may include explanations of correct form, identification of errors, or structured coaching instructions. The data are aligned with specific video sequences from the player video 406 and then directed to the text tokenizer 404 for embedding. The text tokenizer 404 performs the embedding operation for linguistic input described generally above, but specifically here, to text or voice commentary. The tokenizer segments the human-provided language into tokens and maps those tokens into embedding vectors that preserve contextual meaning. These embeddings serve as the language-domain inputs to the multimodal AI model 410.

The player video 406 and vision encoder 408 correspond to the visual input stream previously discussed elsewhere, but here, are expressly used as the training video source for multimodal learning. The videos depict athletic techniques selected for domain-specific training (for example, tennis strokes) and are the raw data from which visual embeddings are derived by the vision encoder 408. The vision encoder 408 applies the visual-embedding functions to the player video 406. It generates feature tensors representing spatial and temporal attributes of motion, such as joint trajectories or pose relationships. The encoder's output aligns with the textual embeddings from the text tokenizer 404 for input to the AI model 410.

The AI model 410 corresponds to the multimodal model described elsewhere and integrates both a Large Language Model (LLM) and a Large Vision Model (LVM). In this embodiment, the AI model 410 is trained using synchronized language and vision embeddings from the linguistic input stream and visual input stream. Its outputs include sport-specific instructions or evaluations identifying performance issues, distinctions between movement styles, and recommended corrections.

The training dataset used in FIG. 4 extends the general data preparation procedures described elsewhere by emphasizing domain-specific curation. The dataset includes raw and pre-processed videos depicting particular techniques, such as body movements or tactical actions, that correspond to the linguistic inputs provided through the human input 402. Each video is prepared for visual encoding through the vision encoder 408 and aligned with tokenized commentary to ensure multimodal consistency. The incorporation of human commentary parallels other implementations, but functions here as a structured component of multimodal training. The human input 402 provides curated descriptions synchronized with corresponding player videos 406, enabling the AI model 410 to learn cross-modal associations between linguistic terms and visual features representing athletic motion.

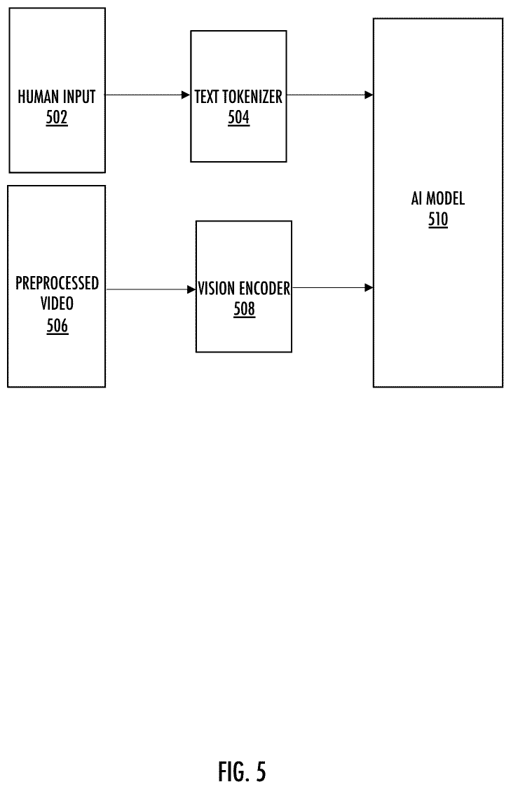

FIG. 5 is a logical flow diagram of a second method for model training. FIG. 5 represents an alternative implementation of the generalized system described with respect to FIG. 3 and extends the training sequence introduced in FIG. 4. The method includes a human input 502, a text tokenizer 504, a preprocessed video 506, a vision encoder 508, and an AI model 510. Unlike FIG. 4, which employs raw visual data, FIG. 5 uses pre-processed imagery and videos that have already undergone annotation or segmentation prior to training. The preprocessed video 506 therefore forms the primary point of distinction, serving as a refined dataset that contains extracted body poses, object trajectories, or environmental features. The remaining components operate as described in previous figures, with embeddings generated by text tokenizer 504 and vision encoder 508 and multimodal training performed by AI model 510.

The preprocessed video 506 represents the principal distinction of FIG. 5 from the prior embodiment of FIG. 4. Rather than raw imagery, this component includes video sequences or image sets that have already been processed by techniques such as pose estimation, object detection, or segmentation. Examples of such preprocessing include extraction of human-body poses, trajectories of a ball, positions of equipment such as rackets or clubs, or identification of static references such as court boundaries and goals. Each frame or key point series in the preprocessed video 506 is encoded to emphasize motion geometry and spatial relations rather than pixel appearance. This abstraction reduces noise and improves convergence during training by supplying only relevant geometric and contextual features.

The human input 502 corresponds to the commentary or instructional data described elsewhere. In this embodiment, the human input provides context or explanation for already-processed visual features rather than for raw video. A coach or analyst may supply text or voice commentary describing the extracted motion data or pose representations contained in the preprocessed video 506. This commentary ensures that the AI model 510 learns to associate descriptive language with abstracted visual cues (e.g., pose estimation, joint speeds, etc.) derived from prior preprocessing. This reduces the likelihood of incorrect associations (based on clothing, other confounding factors, etc.) difficult and/or improves training accuracy.

The vision encoder 508 performs the embedding operation previously described elsewhere but now receives feature-rich, pre-segmented data. Because the visual inputs already contain pose or object-level information, the encoder may employ lighter-weight or specialized layers optimized for feature correlation rather than detection. The resulting embeddings capture spatial and temporal dependencies between extracted entities—such as the relationship between limb movement and equipment motion—and supply these vectors to the AI model 510.

The AI model 510 corresponds to the multimodal architecture described elsewhere but is trained using the preprocessed feature data from 506. The model thus learns relationships between abstracted motion representations and linguistic commentary rather than direct pixel-level imagery. Training on preprocessed data allows the AI model 510 to emphasize structural and biomechanical relationships while minimizing visual variance among subjects or environments. The model output includes textual or symbolic feedback describing movement quality, positional efficiency, or trajectory analysis, consistent with the applications described in earlier figures.

More generally, the training process illustrated in FIG. 5 preprocesses images (pose-estimated frames, segmented body components, and object trajectories, etc.) prior to model ingestion. These processed elements are vision-encoded and then combined with tokenized textual commentary. This workflow enables the AI model 510 to focus on invariant spatial relationships and motion patterns that generalize across players and/or recording conditions. The resulting model retains the multimodal capabilities shown in previous figures but operates on higher-level abstractions of the underlying performance data.

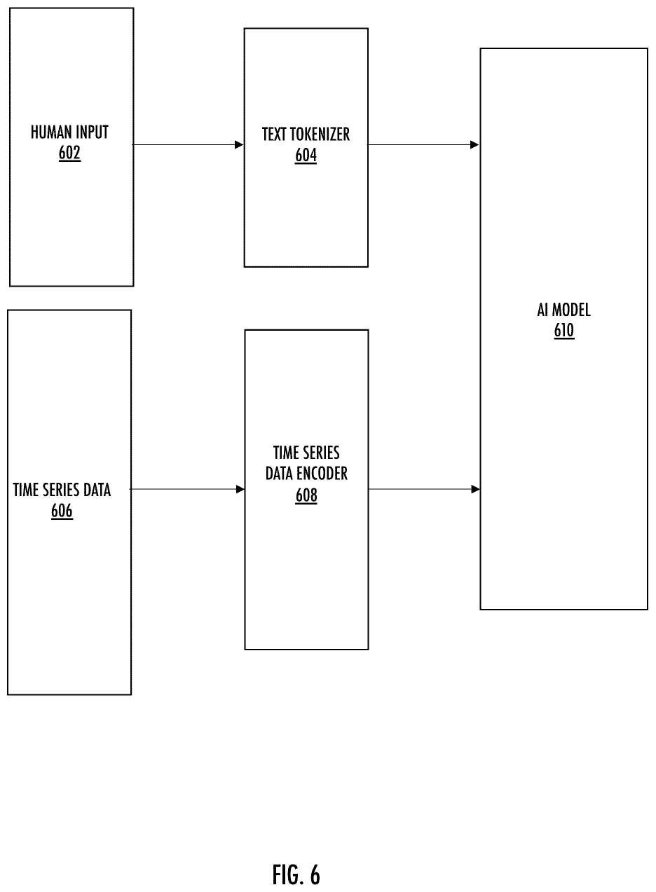

FIG. 6 is a logical flow diagram of a third method for model training. FIG. 6 represents an additional implementation of the generalized training architecture described in FIG. 3 and extends the workflows introduced elsewhere. The method includes a human input 602, a text tokenizer 604, a time series data 606, a time series encoder 608, and an AI model 610. Unlike the visual systems described in FIG. 4 and FIG. 5 which rely on raw or preprocessed visual inputs, the method in FIG. 6 trains the model using derived time-series feature data that capture temporal dependencies in movement. The time series data 606 represent sequences of extracted key features such as body-joint positions, equipment trajectories, or object detections over time. The encoder 608 embeds these temporal features for input to the AI model 610, which learns to interpret dynamic motion patterns in conjunction with textual coaching commentary.

The time series data 606 represents the distinguishing feature of FIG. 6 relative to earlier training methods. The dataset comprises sequentially ordered features derived from raw or preprocessed visual inputs. Each feature sequence may include pose-estimation key points, object detections, or spatial coordinates of equipment and environmental elements. Examples include trajectories of a ball, orientation of a racket or club, or positional paths of specific body joints. The resulting data form a structured time series describing motion progression over time rather than frame-based snapshots. This temporal structure enables the model to capture inter-frame dependencies relevant to kinetic and biomechanical analysis.

The time series encoder 608 processes the time series data 606 to generate embedded representations suitable for model training. The encoder may employ recurrent, transformer-based, or temporal-convolution architectures configured to capture dependencies across time steps. The encoding process maps related feature states—such as the position of a joint over successive frames—into a continuous vector trajectory within a latent space. The resulting embeddings preserve both local and global temporal correlations. This output is aligned with tokenized language embeddings from the linguistic or auditory coaching data path and passed to the AI model 610 for multimodal learning

The human input 602 and text tokenizer 604 corresponds to the linguistic or auditory coaching data path previously discussed elsewhere. In the present embodiment, the commentary is directed toward explaining temporal features of motion—such as rhythm, timing, or sequential coordination—rather than static positions or visual structures. The human input 602 thus provides interpretive language describing motion phases, transitions, and timing relations that are reflected in the associated time series data 606. Here, the tokenizer 604 converts commentary specific to temporal dynamics into embedding vectors that align semantically with the encoded feature sequences from the time series encoder 608. These embeddings allow the AI model 610 to associate language-based timing descriptors—such as “early rotation” or “delayed follow-through”—with corresponding patterns in the key-feature sequences.

The AI model 610 corresponds to the multimodal model previously described elsewhere but is trained here using temporal feature embeddings rather than static image or pose data. The model learns mappings between dynamic movement patterns and linguistic descriptions of performance timing, synchronization, or sequential coordination. During training, the model adjusts parameters to associate descriptive phrases from the human input 602 with time-dependent motion features produced by the time series encoder 608. The resulting trained model can later generate coaching output that identifies temporal inefficiencies, motion sequencing errors, or timing-based recommendations. This approach enables the model to capture continuous patterns of motion, providing a basis for timing-aware feedback generation and more granular interpretation of athletic movements.

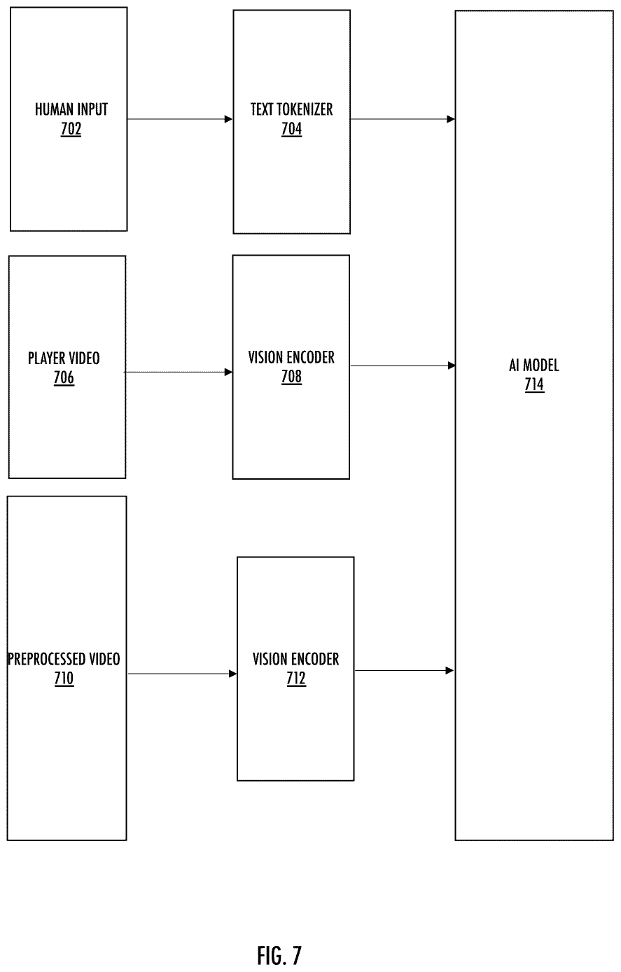

FIG. 7 is a logical flow diagram of a fourth method for model training. FIG. 7 represents a further embodiment of the generalized architecture described in FIG. 3 and incorporates multiple video sources and encoders to improve multimodal data fusion. The method includes a human input 702, a text tokenizer 704, a player video 706, a first vision encoder 708, a preprocessed video 710, a second vision encoder 712, and an AI model 714. The system integrates both raw and preprocessed visual inputs, allowing the AI model 714 to learn relationships between unprocessed motion imagery and higher-level extracted features within a unified training framework. The dual-encoder configuration distinguishes this embodiment from the prior single-stream designs, providing enhanced cross-modal representation learning between text, raw visuals, and feature-enriched video data.

In slightly more detail, the system of FIG. 7 employs a dual vision-encoder data path comprising a first vision encoder 708 and a second vision encoder 712 operating in parallel on distinct but related video inputs. The first vision encoder 708 receives the player video 706, which consists of raw imagery capturing the complete visual scene of an athlete's performance. This encoder extracts features directly from pixel-level data, including global spatial context such as environment, camera orientation, lighting, and relative player position. The embeddings generated by the first encoder therefore preserve holistic visual context, capturing interactions between the athlete, surrounding equipment, and environmental geometry.

In contrast, the second vision encoder 712 operates on the preprocessed video 710, which contains imagery or feature sets derived from prior segmentation, pose estimation, or object detection. This data isolates salient biomechanical and object-based attributes—such as limb trajectories, racket paths, or ball flight—while removing visual elements unrelated to performance analysis. The second encoder produces high-level, semantically structured embeddings that emphasize spatial and temporal relationships among key features rather than raw visual appearance.

Together, these two visual streams provide complementary perspectives on the same underlying activity. The first encoder 708 supplies contextual completeness, allowing the AI model 714 to understand motion in relation to scene geometry and environmental constraints. The second encoder 712 supplies analytic precision, abstracting the motion into normalized feature representations that are invariant to lighting, clothing, or camera variations. During training, the AI model 714 fuses these embeddings through cross-modal attention mechanisms or projection layers, aligning the contextual and analytical representations within a shared latent space.

This dual-stream approach achieves a synergistic effect: the raw-stream encoder grounds the model's perception in real-world context, while the preprocessed-stream encoder distills the essential motion parameters. The result is a multimodal model capable of reasoning across both concrete and abstract domains—recognizing technique accuracy not only by shape and movement but also by situational relevance within the overall scene. Such integration enhances generalization across different training environments and produces more robust interpretive feedback for athletic instruction.

The AI model 714 corresponds functionally to the multimodal network described in FIG. 3 (306) but is here configured for dual-stream fusion of visual embeddings. The model simultaneously receives embeddings from the first vision encoder 708, which represent full-scene contextual information derived from the raw player video 706, and from the second vision encoder 712, which represent structured, feature-level information derived from the preprocessed video 710. These two embedding sets are jointly processed with language embeddings produced by the text tokenizer 704, which encodes the human input 702 into a compatible semantic space.

Within this architecture, the AI model 714 aligns and integrates the two visual domains through cross-attention or projection mechanisms that allow the network to correlate fine-grained biomechanical motion with its corresponding environmental or situational context. The model learns that a movement's meaning and correctness depend not only on local joint trajectories or object paths, but also on how those motions occur relative to the broader playing environment. For instance, the model may associate the shape of a racket swing (captured by the preprocessed stream) with the timing and spatial constraints visible in the raw stream.

This dual-stream fusion provides a synergy that is more efficient than exhaustive single-stream training—in other words, this data flow is specific to athletic applications. While it may be possible to derive similar results using brute force training, this data flow is structurally designed for analyzing body motion relative to environment (e.g., the athlete within the field of the sport). The raw-vision stream offers contextual grounding—preserving visual realism and environmental relationships—while the preprocessed-vision stream provides normalized, noise-reduced abstraction of key movement features. The combined embeddings therefore enable the model to infer higher-order relationships such as technique efficiency, spatial awareness, or consistency of motion under varied conditions. The AI model 714 produces multimodal outputs that integrate descriptive, contextual, and analytical perspectives, thereby generating coaching feedback that is both precise in motion analysis and situationally aware in interpretation.

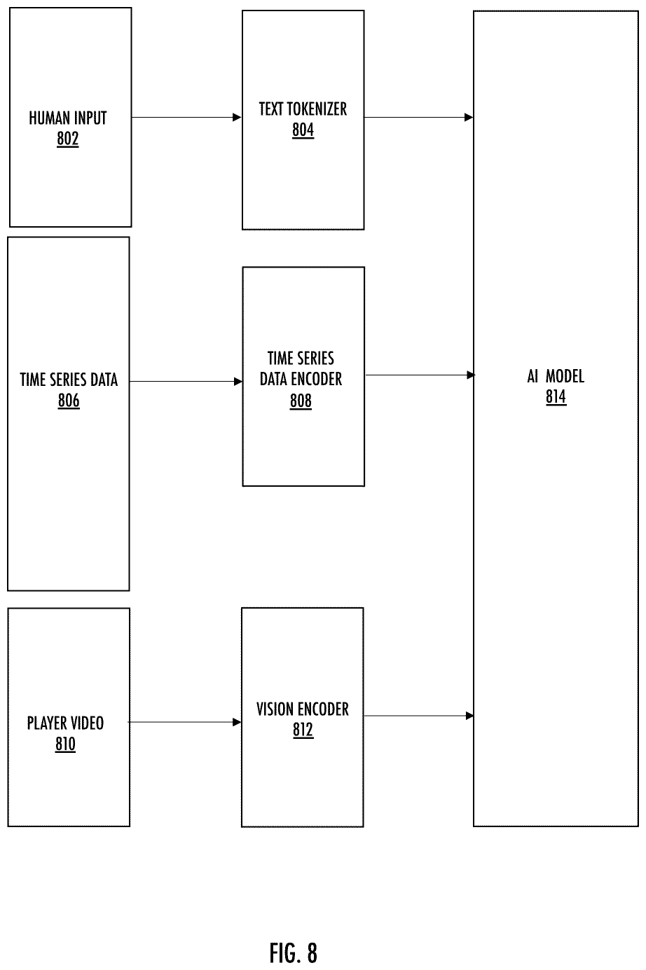

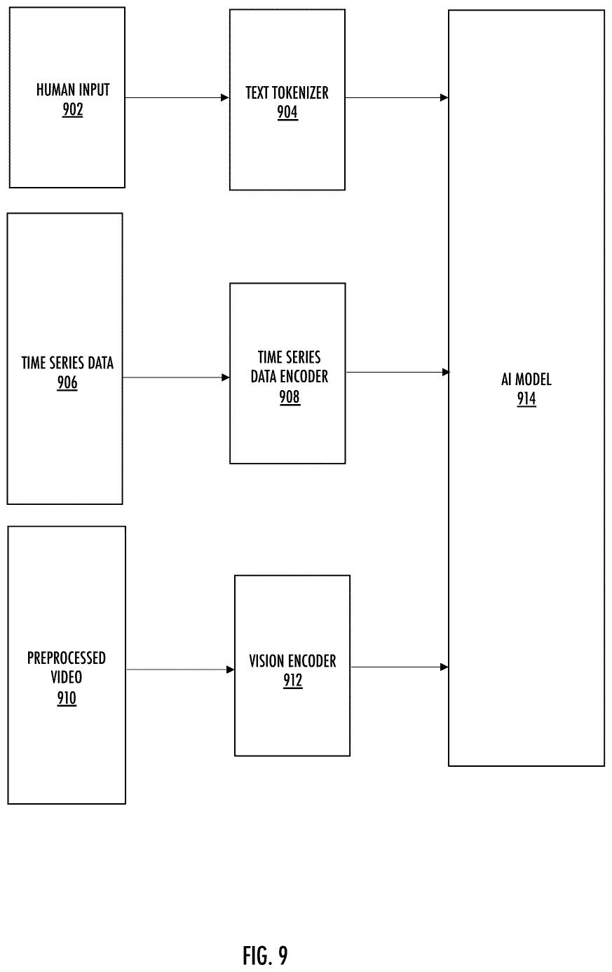

FIG. 8 is a logical flow diagram of a fifth method for model training. FIG. 8 represents a further embodiment of the generalized multimodal training architecture described in FIG. 3, and combines the temporal feature encoding approach of FIG. 6 with the dual-visual-stream fusion method of FIG. 7. The system includes a human input 802, a text tokenizer 804, a time series data 806, a time series encoder 808, a player video 810, a vision encoder 812, and an AI model 814. In contrast to the preceding figures, FIG. 8 integrates temporal and spatial learning pathways within a unified architecture that captures both sequential motion dynamics and visual scene context. The AI model 814 simultaneously aligns linguistic, temporal, and visual embeddings to enable comprehensive interpretation of technique, timing, and environment.

The training operation in FIG. 8 jointly optimizes temporal, spatial, and linguistic domains. Time-series feature sequences (time series data 806) and raw visual data 810 are processed in parallel by their respective encoders, generating complementary embeddings. These embeddings are fused with tokenized commentary within the AI model 814. During training, a joint loss function is computed to minimize discrepancies across modalities, enforcing synchronization between motion timing, visual representation, and linguistic description. This unified optimization allows the model to learn correlations such as motion pacing relative to spatial constraints, producing a temporally and spatially consistent interpretive model. The result is a multimodal training system capable of analyzing not only how an athlete moves, but also when and why those movements occur within their visual and contextual environment.

More generally, while FIG. 8 illustrates one embodiment combining temporal, spatial, and linguistic data, the disclosed architecture is not limited to these specific modalities. In other embodiments, any combination of cross-modal data paths may be employed, including but not limited to visual-audio, visual-sensor, sensor-linguistic, or text-time-series pairings. Each data path may be associated with its own encoder, producing embeddings that occupy a shared latent space for correlation within the AI model. The system may dynamically activate or weight different encoders depending on available inputs or target tasks, enabling scalable integration of additional modalities such as force, biometric, environmental, or contextual data. Through this generalized cross-modal framework, the model can learn hierarchical relationships across diverse information sources, thereby supporting adaptive training and inference across multiple application domains.

FIG. 9 is a logical flow diagram of a sixth method for model training. FIG. 9 represents another implementation of the generalized system described in FIG. 3 and extends the hybrid architectures introduced elsewhere. The method includes a human input 902, a text tokenizer 904, a time series data 906, a time series encoder 908, a preprocessed video 910, a vision encoder 912, and an AI model 914. Unlike previous configurations, FIG. 9 fuses time-series representations derived from motion features with spatially structured visual representations extracted from preprocessed imagery. This combination enables the AI model 914 to learn both how movement evolves over time and how that evolution maps onto spatial relationships between key objects, equipment, or body landmarks.

The AI model 914 corresponds to the multimodal network described elsewhere but implements parallel temporal and spatial fusion rather than hierarchical fusion. The model receives embeddings from both encoders (time series encoder 908, vision encoder 912) and aligns them using shared attention mechanisms or synchronization layers that map temporal evolution onto spatial structure. The model thereby learns to associate motion timing with positional accuracy—for example, identifying that a specific joint trajectory occurs too early relative to an object's path. The linguistic embeddings from the text tokenizer 904 provide interpretive context, allowing the model to link descriptive commentary to these spatiotemporal relationships. The AI model 914 outputs structured feedback identifying not only motion correctness but also the relative coordination between sequential and positional parameters.

The training operation in FIG. 9 differs from the workflows of FIGS. 6-8 by performing parallel encoding and joint optimization of time-series and spatial data streams. The time series encoder 908 and vision encoder 912 process respective data simultaneously, generating synchronized embeddings that the AI model 914 fuses within a shared latent space. During training, the model's loss function is computed over both temporal and spatial alignment terms to ensure consistency across motion dynamics and positional accuracy. This structure provides a synergistic effect, enabling the model to generalize across temporal shifts (timing errors) and spatial deviations (form errors) simultaneously. The resulting multimodal network produces output that captures the interdependence between how and when movement occurs, improving precision in performance evaluation and corrective instruction.

In one specific variant, the training performs synchronous fusion of temporal and spatial representations rather than sequential processing. The model receives three primary input streams: (i) temporal embeddings from the time series encoder 908, representing motion features and their evolution over time; (ii) spatial embeddings from the vision encoder 912, representing geometric relationships and positional configurations derived from the preprocessed video 910; and (iii) linguistic embeddings from the text tokenizer 904, representing human commentary that semantically describes movement timing, technique, and relative positioning. Internally, the AI model (914) includes one or more cross-attention or fusion layers configured to establish direct correspondences between temporal and spatial features. Each fusion layer aligns the output of the time series encoder 908 with the corresponding frame or sequence of spatial embeddings produced by the vision encoder 912. For example, a temporal vector representing acceleration of a limb across several time steps may be mapped to spatial vectors representing limb orientation and tool position during that same interval. These correspondences allow the model to identify how time-dependent motion behavior is manifested as spatial changes in body configuration or object alignment. The model's training process optimizes a joint loss function that incorporates temporal prediction accuracy, spatial reconstruction error, and semantic alignment with language embeddings. This combined loss ensures that temporal timing, spatial positioning, and linguistic meaning reinforce one another during parameter adjustment. Through iterative optimization, the model learns multidimensional relationships such as the co-occurrence of timing errors with positional deviations or the synchronization of joint motion sequences with object trajectories.

Conceptually, this integrated temporal-spatial learning produces a synergistic effect that surpasses isolated modeling of either domain. The time series encoder 908 captures the rhythm and progression of motion, while the vision encoder 912 captures the geometric context in which that motion occurs. The AI model 914 fuses these complementary representations to infer higher-order constructs such as coordination, sequencing, and motion efficiency. As a result, the trained model can generate multimodal outputs that explain why a particular motion sequence deviated from optimal performance, referencing both timing irregularities and spatial misalignments in its evaluation.

In practical application, the AI model 914 supports downstream functions such as automated coaching feedback, motion classification, or real-time correction suggestions. Its fused embeddings enable precise mapping between abstract temporal signals and tangible spatial features, yielding output that is temporally coherent, spatially interpretable, and linguistically meaningful. This architecture therefore provides a unified representation of athletic movement that integrates when actions occur, where they occur, and how they are described within the same multimodal analytical framework.

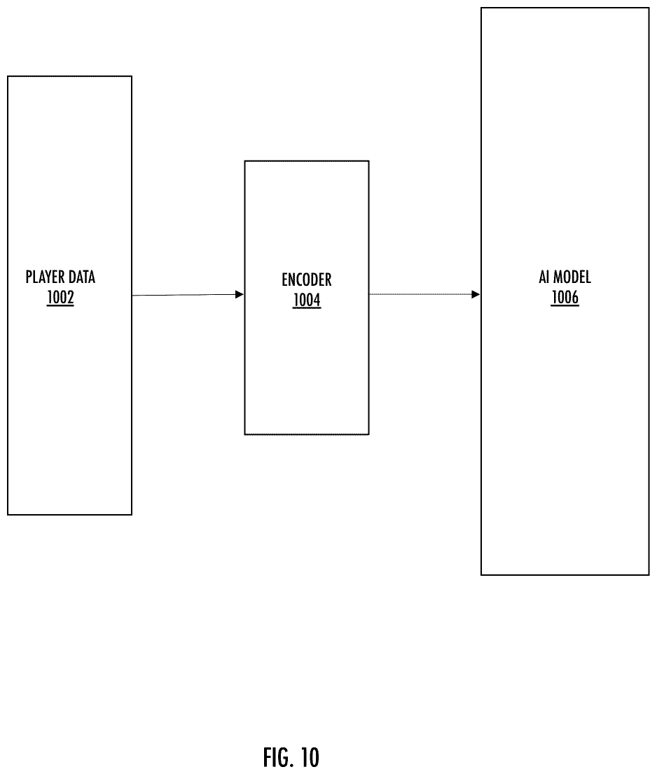

FIG. 10 is a logical block diagram of singleton model training. FIG. 10 represents a specific implementation of the generalized model training system applied to an individualized, player-specific context. The system includes input data 1002, an encoder 1004, and an AI model 1006. In this embodiment, the model is trained using a single-player data stream, which may consist of one or more videos of that individual, together with corresponding human commentary describing the technique or performance attributes. The singleton configuration enables fine-tuning of the model to a particular player's motion characteristics, biomechanics, and stylistic patterns while retaining compatibility with the broader multimodal framework described elsewhere.

The input data (1002) comprises the individualized dataset for a single player. This dataset may include raw video recordings, preprocessed or annotated imagery, and derived feature data such as pose-estimation coordinates, key-feature time series, or motion-tracking metadata. The input data 1002 are confined to a single player identity, allowing the model to isolate intra-subject variation across multiple sessions or techniques. The training input may be presented as a continuous stream or as sequentially indexed samples representing distinct techniques (such as serve, forehand, or backhand motions). Each sample is paired with coaching commentary describing the correctness, quality, or category of execution.

The encoder 1004 performs the feature-embedding functions specialized for player-specific feature extraction. The encoder converts visual or temporal data from the input 1002 into embedding vectors that characterize the unique motion patterns of the individual player. Because the dataset is limited to one subject, the encoder may emphasize intra-player variability—such as differences between successful and unsuccessful attempts of the same technique—rather than inter-player differences. The encoder 1004 may operate as a vision encoder, time-series encoder, or combined multimodal encoder depending on the data composition. Its output embeddings are fed to the AI model 1006 for classification and correlation with the associated human commentary.

The AI model 1006 corresponds to the multimodal network described elsewhere but is configured here for singleton learning—that is, model optimization based on data from one individual at a time. During training, the model receives embeddings from the encoder 1004 together with linguistic embeddings derived from the associated commentary. The model adjusts its parameters to learn the relationships between the player's motion patterns and the qualitative assessments provided by the coach.

The training process may include both technique-level and key-feature-level categorization. For example, entire sequences may be assigned categorical labels such as “right,” “wrong,” “beginner,” “advanced,” etc. while individual movement features—such as hip rotation or wrist angle—may be separately classified. Virtually any labeling scheme may be used with equal success to provide greater granularity and/or wider spectrum for evaluation (e.g., “aggressive”, “conservative”, “balanced”, “textbook”, “unorthodox”, “erratic”, etc.). Categories may be predefined based on coaching standards or dynamically inferred from human input using clustering or attention-weighted comparison across embeddings. By learning from these labeled examples, the AI model 1006 develops a spectrum of technique representations specific to the player's performance profile.

As used herein, the term “skill-specific” and its related linguistic derivatives refer to associations/relationships to a skill, key-feature, technique, or other aspect of game play. For example, the AI model might associate hip rotation and wrist angle as distinct skill-specific factors for a tennis swing. Similarly, the AI model might relate certain stances with aggressive/conservative play. More generally, a variety of different skill-specific labels may be used for categorization for training (and/or inference during operation).

Individualized training enables the model to distinguish between stylistic variations and mechanical errors, allowing subsequent inference to deliver personalized coaching outputs. In later deployment, the singleton-trained parameters may be aggregated or fine-tuned alongside group-trained parameters from other players, enabling adaptive personalization within the broader training ecosystem.

In one specific embodiment, personalized coaching outputs may be organized within a “personalized progressive pathway”. Conceptually, there are a myriad of possible skill deficits—so, personalized coaching that identifies an individual's specific deficits is often far more useful than “one-size-fits-all” coaching. Furthermore, effective skill development often relies on learning smaller pieces, that are synthesized together. For example, a person might overcorrect for poor posture/stance with exaggerated wrist movement—both elements are incorrect and must be improved, but the person should focus on correcting their stance first, reducing the need for overcorrection thus allowing the wrist movements to naturally improve. By constructing a personalized “pathway” between targeted individual skill exercises, the person can improve in distinct and measurable stages (“progressive” improvement).

The training operation for FIG. 10 uses a sequential singleton approach. Each training cycle processes a dataset corresponding to one player, and subsequent cycles incorporate additional singleton datasets. The AI model 1006 may therefore be trained incrementally, using each player's dataset to refine different regions of the learned feature space. While the model training may “sandbox” refinements for each player; this allows the model to learn the specific nuances to a player (rather than blending). In some cases, the model may generalize overarching concepts by aggregating learned representations from multiple single-player training session sandboxes.

Within each singleton sandbox, the model learns both categorical distinctions (e.g., correct versus incorrect form) and continuous performance gradients (e.g., speed or smoothness of motion). The system may apply contrastive or metric-learning objectives to ensure that embeddings from similar actions cluster together while dissimilar actions remain separable. As a result, the trained model retains both the specificity of individualized understanding and the generality required for multi-user inference. The singleton training method thus provides a scalable approach for personalized fine-tuning that complements multimodal and cross-modal fusion strategies.

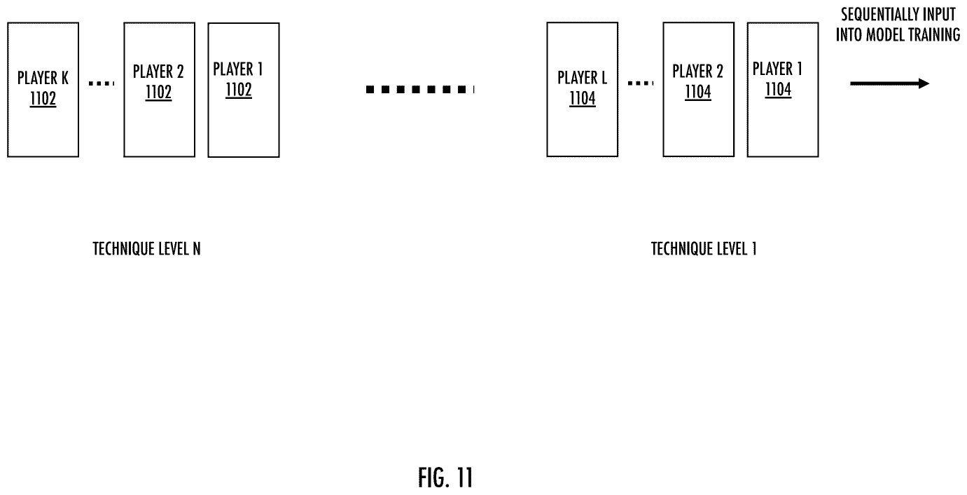

FIG. 11 is a graphical representation of one possible training data set arrangement. FIG. 11 illustrates how player-specific data sets are categorized and sequenced to provide structured input for the AI model training processes described elsewhere. The system includes at least first input data 1102 and second input data 1104, each representing collections of player recordings and corresponding annotations. The input data may originate from any number of players across a range of skill levels and competitive tiers.

Skill levels can be defined differently in different sports; skill level refers to any quantitative metric for measuring a player's skill level. For example, Universal Tennis Rating (UTR) and World Tennis Number (WTN) are two examples of ratings used in tennis. Skill level may be an objective measurement (e.g., a numerical score, rating, ranking, or similar metric) or subjective assessment (e.g., “beginner”, “intermediate”, “expert”, etc.). For example, a golfer might have a handicap, a skier might be categorized into an intermediate skier based on their preferred skill and terrain, etc.

Skills broadly encompass e.g., raw athletic ability (e.g., strength, range of motion, cardiovascular fitness, etc.), individual techniques and/or combinations (e.g., biomechanical movements, etc.), and/or strategy/tactics (e.g., ball placement, location within a field, player interactions, etc.). These skills may be objectively measured and/or subjectively assessed. For example, skills may use e.g., key performance indicators (e.g., average aces per match, first serve percentage, first serve points won, second serve points won, double faults, etc.), physical fitness metrics (e.g., 5-0-5 agility test, T-tests, vertical jumps/medicine ball throws, etc.), player heat maps (e.g., time spent in the defensive zone, neutral zone, aggressive zone, and/or kill zone, etc.) any other indicia of skill.

Players are grouped into categorical levels, and their corresponding data sets—videos, annotations, and coaching inputs—are organized within various levels to form a stratified database. This data arrangement allows the model to learn performance variations across different skill strata, establishing a continuous representation of athletic proficiency.

Player data may include players from various rating systems or coaching evaluations. Each player's data may contain raw or preprocessed videos, time-series features, and human commentary corresponding to specific techniques. The input data thus serve as the foundational layer of the dataset from which the neural network begins its initial exposure to performance diversity. These data can be curated from multiple players within a single rating level, allowing the model to establish intra-level variability and baseline behavioral representation.

In some implementations, the input data may rank players of progressively higher or lower ability levels, such that the system incrementally learns transitions across performance tiers. The data sets may be introduced sequentially, allowing the AI model to adjust its parameters to capture both inter-level distinctions and intra-level refinements. Each new input batch contributes to expanding the learned representation of technique proficiency, thereby enabling the model to infer relative skill placement and performance trajectory.

Players may be assigned to one of N different levels, determined either by human coaching assessment or by an external rating system. Subjective classification systems—such as the United States Tennis Association (USTA) player ratings—may categorize players using observational criteria, while objective systems—such as Universal Tennis Rating (UTR) or World Tennis Number (WTN)—may assign numerical scores derived from match results and statistical measures. In one example, N may range between 10 and 20, defining discrete levels of player ability. Datasets within each level are used sequentially as training input, enabling the AI model to learn the feature distribution and movement characteristics associated with each proficiency range. This structured stratification allows the model to generalize across performance levels and to provide feedback appropriate to the user's developmental stage.

A comprehensive database may be assembled using player videos sourced from diverse competitive circuits, including professional, collegiate, junior, and amateur levels. Each video is annotated and labeled by qualified coaches, who assign a level designation for each technique based on their own evaluation standards. In addition to numeric or categorical labels, coaches may append commentary, instructions, and recommendations describing how a player could improve to reach the next level. These annotated datasets thus contain both qualitative assessments and quantitative features, supporting multimodal alignment between language, motion, and performance metrics. The database can be used for model training, fine-tuning, retrieval-augmented generation (RAG), and inference operations, providing a unified corpus that links visual data, feature data, and human expertise.

The data set arrangement of FIG. 11 is compatible with all model training configurations, including generalized multimodal, temporal-spatial, and singleton training modes. In some embodiments, singleton training (e.g., as described in FIG. 10) may be used within or alongside the stratified dataset to perform player-specific fine-tuning within a defined skill level. The organized structure of player levels allows the AI model to interpolate between group-level learning and individual-level refinement, enabling both global and personalized adaptation. This integration ensures that the database functions as a scalable foundation for progressive learning, supporting model updates as additional players or performance levels are incorporated.

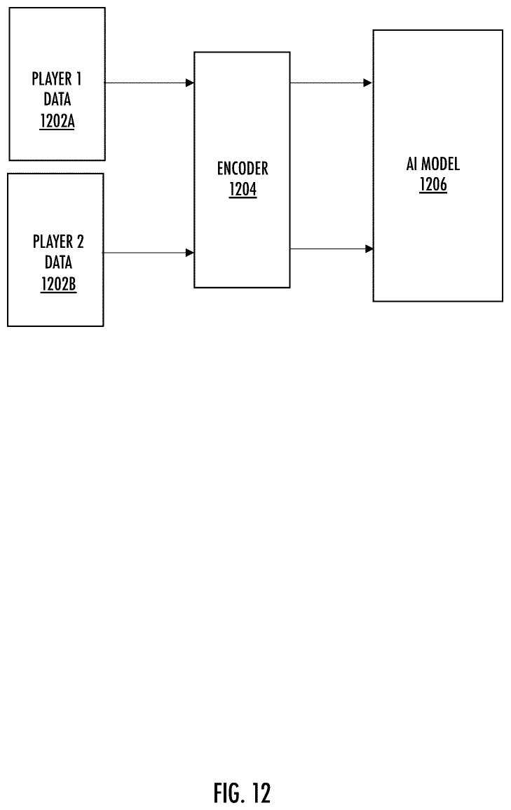

FIG. 12 illustrates a duo training configuration. The system includes first input data 1202A, second input data 1202B, an encoder 1204, and an AI model 1206. In this embodiment, two player data streams are provided as concurrent inputs to the model during training. The first input data 1202A and second input data 1202B represent two diverse data sources used to generate paired training examples.

Each data source may include raw or preprocessed videos, pose-estimation results, key-feature time series, or other derived representations of motion. Each stream may represent data from different players, or from the same player at different times, such as before and after instruction. In some embodiments, the diverse inputs correspond to players of different ability levels—such as a professional and an amateur—while in others, they may represent the same player performing at distinct time points or under different conditions. The paired data structure allows the model to learn comparative relationships between techniques, skill levels, or temporal progressions. This pairing allows the training process to establish relative mappings between two instances of technique execution, rather than learning in isolation from single data streams. The paired datasets provide the foundational structure that enables duo training to encode notions of improvement, difference, and equivalence across players or timeframes.

The encoder 1204 performs the embedding functions described elsewhere, but is configured here for dual-stream synchronization and feature alignment. The encoder receives inputs from both data sources simultaneously, extracting corresponding feature representations from each. The term “simultaneously” in this context denotes that the paired data streams are processed in parallel computational paths during the same training step, such that their encoded embeddings are temporally and semantically aligned. The encoder may employ synchronized temporal windows or shared positional embeddings to ensure that features extracted from equivalent motion phases are directly comparable. This simultaneous encoding allows the model to evaluate structural, temporal, and stylistic differences between two motion sequences within a unified latent space.

The AI model 1206 corresponds functionally to the multimodal architectures described elsewhere but implements a comparative learning objective specific to duo training. The model receives paired embeddings from the encoder 1204 and computes relational metrics that quantify differences or similarities between the two data sources. During training, the model may learn to associate one input as a reference and the other as a target, allowing it to infer corrective directions or relative performance gaps.

The model's optimization process may include contrastive or triplet-loss functions that minimize the distance between embeddings representing equivalent or improved techniques and maximize the distance between embeddings representing incorrect or degraded forms. This relational framework enables the model to recognize relative skill deltas rather than static classifications. For example, when provided with data from a professional and an amateur, the model learns the differentiating biomechanical and temporal patterns that define expert-level execution. When trained using the same player at two different time points, the model can infer progress and identify residual deficiencies.

By aligning both data streams in a shared latent space, the AI model 1206 develops pairwise feature correlation, which yields a synergy not achievable with single-player or singleton training. It learns not only what constitutes correct form but also how motion evolves toward that form, supporting personalized improvement modeling during inference.

The training operation of FIG. 12 differs from prior embodiments by incorporating paired and simultaneous input processing. Two streams of player data—first input 1202A and second input 1202B—are encoded in parallel by encoder 1204, and their embeddings are fused within the AI model 1206 through comparative layers or attention mechanisms. During each training iteration, the model evaluates relational patterns, adjusts its parameters based on relative differences, and refines its internal mapping of skill progression. This process allows the network to develop a graded understanding of technique improvement and inter-player variance.

The benefit of simultaneous dual-stream training is that the model learns to interpret differences contextually—recognizing that biomechanical variation may be advantageous or detrimental depending on the player's reference class or training goal. As a result, the model generalizes across both absolute and relative performance standards, enabling inference outputs that include comparative metrics such as “closer to professional form” or “improved from prior session.” This comparative modeling approach strengthens the interpretability and adaptability of the AI system when applied to diverse users or evolving player profiles.

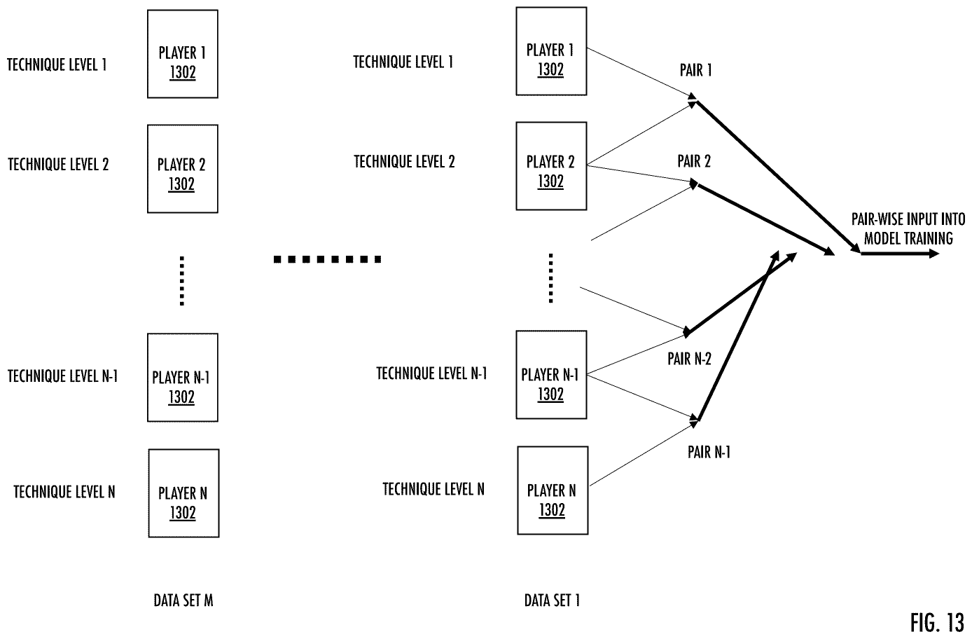

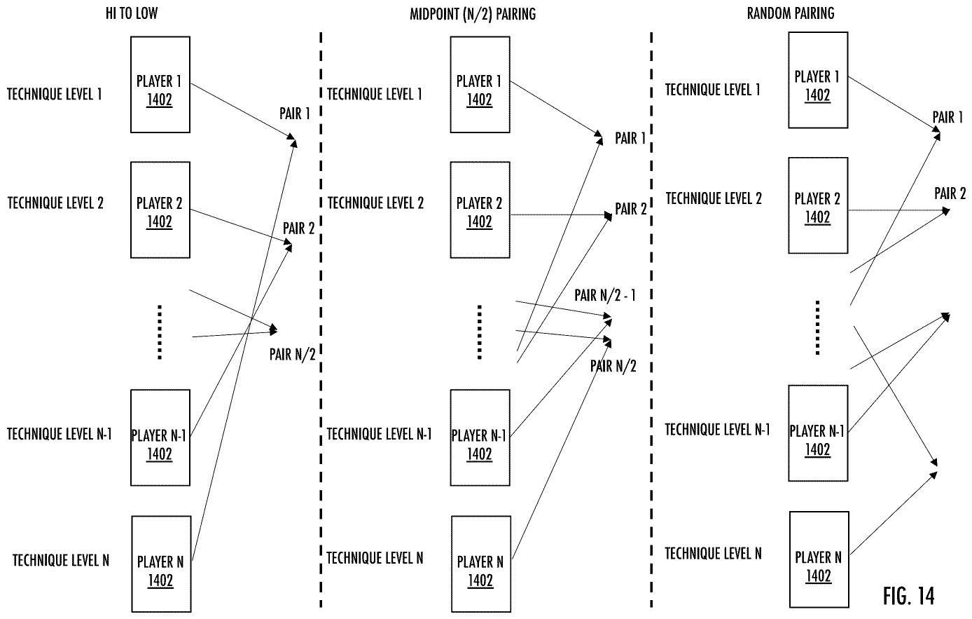

FIG. 13 is a graphical representation of a first arrangement of training data sets for duo training. FIG. 13 extends the comparative model-training framework described in FIG. 12 by illustrating how player data are systematically paired to generate relational examples for training the AI model. The figure includes player video 1302, which represents multiple sets of video data collected from N different players, each belonging to a distinct skill level or rating category. These player videos form structured data sets used to establish paired relationships—such as high-to-low or low-to-high proficiency pairings—that provide the comparative foundation for duo training. The described arrangement ensures balanced exposure across skill levels, allowing the AI model to learn progressive transitions in performance quality.

Player video 1302 represents a collection of N videos or image sequences, each corresponding to a unique player performing the same or similar technique at a distinct ability level. The videos may originate from datasets such as those described above, where players are categorized into discrete proficiency levels based on human ratings or objective metrics. Within each dataset, the player videos are arranged in either ascending or descending order of skill level—such as beginner to advanced or vice versa. The ordered sequence of player video 1302 thus provides the structural basis for defining the pairwise relationships used during duo training

In one embodiment, the ordered player videos are paired sequentially according to an N−1 pairing scheme. For each data set, players ranked at adjacent levels are grouped into pairs: first and second, second and third, continuing through N−1 and N. This produces N−1 unique pairs from N players. Each pair of videos represents a comparative training instance depicting the performance difference between two consecutive skill levels. The AI model thereby learns relative distinctions in form, timing, or execution that correspond to progressive improvement. Once all M datasets are used, each with N players, the process repeats sequentially until all possible level-pair combinations have been exhausted. This configuration enables the model to infer performance transitions continuously across the entire skill spectrum.

In another embodiment, players within each dataset are paired according to an N/2 pairing scheme. In this configuration, the ordered player videos are grouped by alternating indices—such as players one and two, three and four, and so forth—producing N/2 pairings for each dataset. This arrangement emphasizes more distinct contrasts between non-adjacent skill levels while reducing redundancy among closely similar pairs. The N/2 scheme may be used in combination with or as an alternate cycle to the N−1 scheme, allowing the AI model to capture both fine-grained progression and coarse-level differentiation across ability categories. Once all M datasets are processed, the pairing pattern can be reinitialized with inverse ordering (e.g., high-to-low instead of low-to-high) to further balance the comparative exposure.

After all M datasets are processed using the defined pairing method, additional datasets of N players representing new or overlapping levels may be introduced in subsequent training cycles. Each new dataset reinforces the comparative relationships already learned while contributing unique examples from previously unseen player combinations. Over successive iterations, the model incrementally refines its internal representations of relative technique proficiency and develops robust pairwise discrimination capabilities. This cyclical and hierarchical pairing structure enables the AI model to generalize beyond individual pairs, forming a continuous and scalable understanding of performance differences across entire skill populations.

FIG. 14 is a graphical representation of various other arrangements of training data sets. FIG. 14 builds upon the comparative training structures illustrated in FIG. 13 and demonstrates additional methods for pairing player videos or images to generate duo-training inputs. The figure includes player video 1402, which represents N individual player recordings or image sequences, each corresponding to a distinct level of proficiency or technique. The figure illustrates several possible pairing arrangements—ordered, symmetric, random, and category-based—that can be used independently or in combination to provide diverse comparative input configurations for the AI model. These arrangements expand the model's ability to generalize across skill ranges and learning scenarios.

In one embodiment, players are paired according to a mirrored, edge-based configuration, where videos or images from the player at the highest skill level (player 1) and the player at the lowest skill level (player N) form the first pair. The next pair consists of player 2 and player N−1, followed by player 3 and player N−2, and so forth, for a total of N/2 pairs. This symmetrical pairing approach emphasizes contrastive learning between the most divergent skill levels, allowing the AI model to identify the largest qualitative and biomechanical differences in movement. By exposing the model to maximal contrast, this configuration enhances its ability to interpret distinctions between high-level and low-level techniques across varied movements.

In another embodiment, players are paired according to a midpoint-offset scheme in which player 1 is paired with player N/2+1, player 2 with player N/2+2, and so on, for a total of N/2 pairs. This approach provides a balanced comparison between upper-and lower-middle skill levels rather than only the extremes. It allows the model to learn subtle differences between players whose proficiency levels are closer together, capturing intermediate-level distinctions that may not appear in high-to-low pairings. Sequential use of both the edge-pairing and midpoint-offset arrangements enables the model to learn contrast across the entire range of player skill distributions.

In a further embodiment, N players of N different levels are paired randomly to form N/2 pairs per dataset. The random pairing approach introduces statistical diversity in the training examples and prevents overfitting to specific level-based pairings. Over multiple training cycles, randomization ensures that each player is paired with multiple distinct counterparts, exposing the AI model to a wide variety of comparative contexts. In yet another variant, each player is paired with every other player, forming a total of N×(N−1)/2 unique pairs. This exhaustive pairing scheme maximizes coverage of all possible relational combinations, allowing the model to learn generalized patterns of difference and similarity across the entire dataset. The random and exhaustive schemes are particularly useful for fine-tuning and cross-validation phases, where broad relational diversity improves the robustness of learned representations.

In another embodiment, N players within a dataset are divided into two categorical groups: a technically correct group and a technically incorrect group. Pairs are formed by randomly selecting one player from each group, generating N/2 pairs for each dataset. This pairing strategy directly teaches the model to distinguish between correct and incorrect forms, independent of skill level. The model learns to associate the geometric and temporal signatures of proper technique with one input stream and improper execution with the other, strengthening its classification accuracy for error detection during inference. The process may be repeated across all M datasets, ensuring consistent exposure to positive and negative examples throughout training.

The training arrangements depicted in FIG. 14 are compatible with any of the architectures described in above. These pairing schemes may be selected dynamically or used in alternating cycles to emphasize different relational features—contrastive, balanced, random, or categorical. By combining multiple pairing modes within the same training pipeline, the AI model can learn hierarchical relationships across skill ranges and movement quality dimensions. This integration enhances generalization across user populations, enabling the system to deliver comparative coaching feedback that adapts to each player's context and proficiency level.

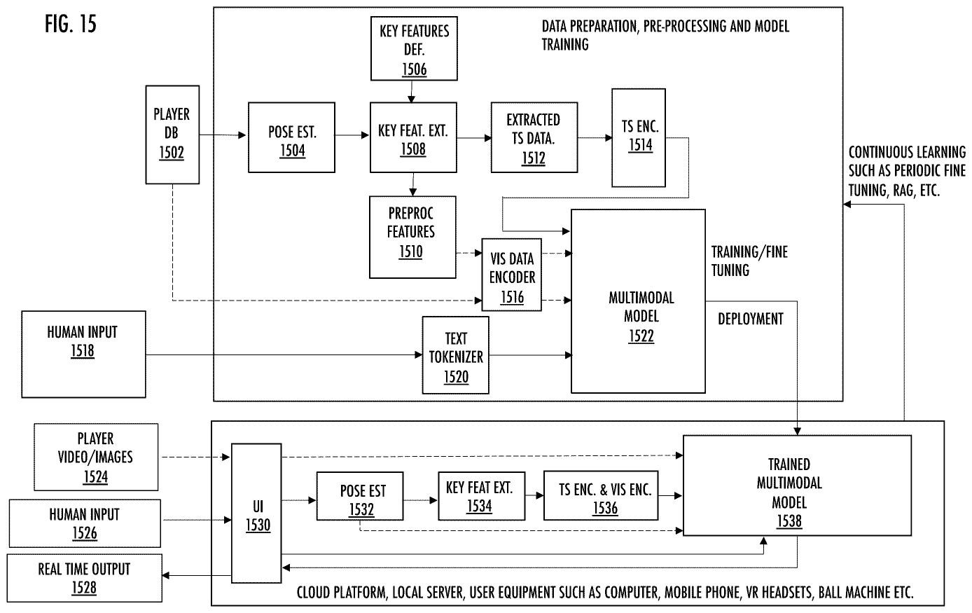

FIG. 15 is a logical block diagram of one detailed system architecture operable within a cloud environment, an on-premises server, user equipment, etc. FIG. 15 integrates the various training and inference functions described elsewhere into a distributed computing framework. The system includes a player video/image database 1502, pose estimation 1504, key features definition 1506, key feature extraction 1508, pose estimated and key feature annotated data set 1510, extracted time-series data set 1512, time series encoder 1514, visual data encoder 1516, human input 1518, text tokenizer 1520, multimodal model 1522, player video/images (inference phase) 1524, human input (inference phase) 1526, real-time output (inference phase) 1528, user interface 1530, pose estimation 1532, extraction of key features 1534, time series encoder and visual data encoder 1536, and a trained multimodal model 1538 configured for continuous learning. The architecture supports both cloud-based model training and deployment of inference modules across distributed environments, including on-premise servers, mobile devices, and third-party training equipment.

The player video/image database 1502 functions as the primary repository for all visual training and inference data. It stores raw and preprocessed videos or images captured from multiple players across various skill levels. The pose estimation 1504 component processes each video frame to detect body landmarks and generate skeletal pose representations. These pose data serve as structured input for subsequent modules, allowing movement analysis to be represented numerically and visually. The database and pose-estimation layer collectively form the foundational visual pipeline for both model training and inference operations.

The key features definition 1506 defines the measurable attributes derived from pose estimation results or other sensor data, such as joint angles, limb velocities, or object trajectories, which can be represented by time series data sets or visual data sets. These features may be predefined according to sport-specific metrics or dynamically generated using automated detection algorithms. The key feature extraction 1508 module isolates and encodes these attributes from the pose data, producing structured datasets suitable for machine-learning input. The resulting information is stored within the pose estimation and key feature annotation visual data set 1510, which links extracted features that are represented by visual data. Together, these elements convert unstructured visual data into a standardized, labeled dataset usable across multiple training modalities.

The extracted time-series data set 1512 includes the annotated feature in the form of time series data. The module serves as input into time series encoder 1514,

The time series encoder 1514 transforms a series of data sets (1, 2, 3-dimension or higher) along the time axis into numerical embeddings that occupy a multi-dimensional latent space.

As a brief aside, “latent space” in the machine-learning arts refers to a representation of data points that map features to dimensions (e.g., typically in high multi-dimensional space e.g., hundreds, thousands, etc.); this allows data points that have similar relationships to be transitively positioned relative to one another. In other words, the distance vector between points in latent space describes their transitive similarity. As a basic conceptual example, consider two points “male” and “female” in a latent space; the distance vector from the “male” to the “female” point could be translated to a different point e.g., “king” to identify a point having a similar relationship (“queen”).

The visual encoder 1516 transforms the structured data (visual, temporal, and feature-based data) into numerical embeddings that occupy the multi-dimensional latent space. In parallel, the human input 1518 provides textual or verbal commentary explaining the observed motion, similar to the linguistic input modules discussed elsewhere. This commentary is processed by the text tokenizer 1520, which converts the language into embedding vectors representing semantic meaning. Together, these components prepare multimodal input vectors that combine encoded motion data with language-based interpretation for training the multimodal model 1522.

The multimodal model 1522 integrates the encoded data streams from time series encoder 1514, visual encoder 1516 and tokenizer 1520, learning to correlate human commentary with corresponding visual and temporal patterns. During training, this model operates in the cloud environment using data stored in the player database 1502 and its derived datasets (pose estimation and key feature annotation visual data set 1510, extracted time series data sets 1512, etc.). Once trained, the model can be deployed for inference across multiple environments. In one configuration, inference runs in the cloud for centralized processing; in another, a compact model instance is deployed locally on a user device, such as a smartphone or training apparatus (computer, mobile phone, VR headsets, ball machine etc.). This distributed architecture allows both centralized training and decentralized inference using shared model parameters.

During inference, the player video/images 1524 and human input 1526 serve as the input streams to the trained multimodal model 1538. The system receives new recordings of a player's performance and, optionally, real-time commentary from a coach or user. These inputs are processed through corresponding encoders and embedded into the model's latent space. The real-time output 1528 is generated as a multimodal prediction vector that may include problem detection, personalized coaching guidance, training recommendations, or indicators of potential injury risk. The output can be displayed or transmitted through the user interface 1530, which provides visual, textual, or audio feedback to the user.

The user interface 1530 provides access to the inference system via a mobile application, web interface, or terminal-based command-line environment. Depending on deployment, the interface may interact with cloud-based APIs or communicate with on-device inference modules. The distributed inference pipeline includes pose estimation 1532, extraction of key features 1534, and time series encoder and visual encoder 1536, which mirror their training-phase counterparts but operate at runtime on live or uploaded user data. The trained multimodal model 1538 performs inference using encoded representations of both time series data and visual data from the multi-dimensional latent space data provided from the training in 1522. This model supports continuous learning—including periodic fine-tuning, retrieval-augmented generation (RAG), and adaptive parameter updates—allowing ongoing model improvement as new data become available.

The architecture of FIG. 15 supports cloud-based model training while enabling inference in diverse environments such as servers, mobile devices, or embedded training equipment. The inference process uses raw or preprocessed player data, pose-estimation outputs, extracted key features, and human commentary as input to the system's encoders. The resulting embeddings are used to retrieve relevant reference data from the continuously expanding player database 1502, which is maintained as a vector-indexed knowledge base. This configuration allows the system to generate contextually relevant coaching output by comparing new performance data against existing encoded representations. By maintaining synchronization between the central training model and distributed inference modules, the system achieves scalable, real-time evaluation and instruction delivery.

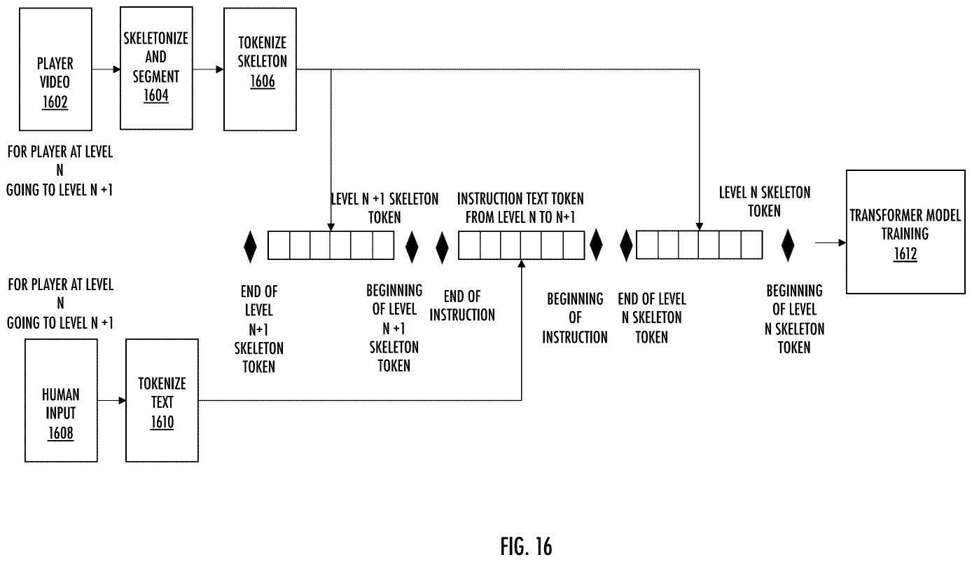

FIG. 16 is a logical block diagram of one method for model training based on pre-training of a transformer model. FIG. 16 extends the concepts described above to a token-based transformer architecture that represents both motion and linguistic data as sequential tokens. The figure includes player video 1602, skeletonization and segmentation 1604, tokenization of skeleton 1606, human input 1608, tokenization of text 1610, and transformer model training 1612. The system converts video and commentary into discrete token sequences that can be ingested by a transformer model for cross-modal learning. This configuration allows the model to encode temporal dependencies in motion alongside semantic relationships in human instruction, enabling pre-training across technique levels or player categories.

Transformer models represent a fundamental advancement in machine learning architectures because they enable efficient and scalable processing of sequential and multimodal data. Unlike recurrent or convolutional networks, transformers use self-attention mechanisms to model relationships between all elements in a sequence simultaneously, regardless of distance or order. This allows the model to capture both local dependencies (such as frame-to-frame motion) and global context (such as the overall structure of a technique or the meaning of a sentence) within a unified framework.

In the context of athletic performance modeling, transformer architectures are particularly valuable because they can jointly learn from heterogeneous modalities—such as skeletal pose sequences, video features, time-series data, and linguistic commentary—by representing each as a stream of tokens within a shared embedding space. The same architecture that powers large language models can therefore be extended to multimodal understanding, allowing it to interpret human instruction, detect motion anomalies, and generate natural-language coaching feedback.

Transformers also support transfer learning and pre-training, enabling models trained on large generic datasets to be fine-tuned efficiently for specialized domains like sports analytics. Their scalability, data efficiency, and generalization capacity make them ideal for building continuously improving systems such as the multimodal AI training architecture described herein.

Player video 1602 represents the primary visual input for the transformer-based model training. In one embodiment, the training data include videos depicting a player performing a defined technique at level N and level N+1, where the videos may originate from the same player or from different players. This structure enables comparative modeling across proficiency levels within a consistent motion category. Each player video may include one or more sessions that record incremental improvements, forming a sequential hierarchy of motion data. These recordings serve as the foundation for generating skeleton-based motion representations used in subsequent processing steps.

The skeletonization and segmentation 1604 process converts the player video 1602 into a structured skeletal representation of motion. The system applies pose estimation and object-tracking algorithms to extract joint coordinates and movement trajectories across sequential frames. The resulting skeletal data are segmented into motion units or action windows, each corresponding to a defined phase of the player's technique—such as setup, execution, and follow-through. This segmentation ensures that each temporal segment represents a meaningful and contextually bounded portion of the overall motion, forming discrete units suitable for tokenization.

The tokenization of skeleton 1606 converts the segmented skeletal frames into a sequence of numerical or symbolic tokens. Each token may represent a pose vector, joint-angle configuration, or a transition between consecutive skeletal states. These tokens form a temporal sequence analogous to words in a sentence, where the order of tokens encodes the progression of motion. The tokenized skeleton thus provides a compact, discrete representation of movement that the transformer model can process natively, enabling the application of natural-language-style sequence modeling to biomechanical data.

The human input 1608 provides descriptive or instructive content that explains the motion represented in the player video 1602. In one embodiment, the human input is provided as speech and converted to text using a speech-to-text module. The commentary may describe differences between the level N and level N+1 performances, specifying aspects such as body alignment, timing, or control improvements. This input provides semantic context for the movement data, establishing a linguistic reference for what distinguishes one skill level from another. The textual representation is subsequently processed for tokenization.

The tokenization of text 1610 processes the transcribed human input to create linguistic embeddings compatible with the transformer model's vocabulary space. Each word, phrase, or structural element is represented as a discrete token, forming an ordered sequence that captures grammatical and semantic relationships. The tokenized text may include descriptors of movement quality, coaching terminology, or explicit numeric thresholds (e.g., “increase angle by 15 degrees”). The tokenized textual data align temporally and semantically with the corresponding motion tokens from the skeleton sequence, allowing both modalities to be fused during transformer training.

The transformer model training 1612 represents the pre-training phase of the transformer or other generative AI model that accepts the multimodal tokenized inputs. The model receives the tokenized skeleton sequence from 1606 and the tokenized text sequence from 1610, aligning them through positional encoding and cross-attention mechanisms. Each transformer layer learns contextual relationships within and between the motion and language tokens, establishing latent representations that describe the mapping between physical technique and verbal instruction.

In one embodiment, the model may also be adapted for architectures beyond transformers, such as multimodal generative AI models, where preprocessing and tokenization schemes differ. Regardless of architecture, the training process leverages pre-training and fine-tuning stages, where general motion-language correspondence is learned first, followed by domain-specific refinement using sports or technique-based data. The model ultimately acquires the ability to interpret, evaluate, and generate coaching feedback by reasoning jointly over temporal motion structure and descriptive text.

The training operation illustrated in FIG. 16 differs from prior methods by converting all input modalities into tokenized sequences for unified transformer processing. The skeletonization and text tokenization pipelines operate in parallel to create temporally synchronized motion and linguistic token streams. These streams are concatenated and input sequentially into the transformer model, which learns their interdependence through self-attention.

This pre-training process allows the model to generalize across players, techniques, and skill levels by understanding the abstract relationships between motion and meaning. Once trained, the transformer model may be fine-tuned using specific sports data or integrated into the multimodal architecture described in FIG. 15 for inference and continuous learning. The transformer-based approach provides a scalable foundation for future models that reason across structured motion data and unstructured language, unifying biomechanical representation and semantic interpretation within a single learning framework.

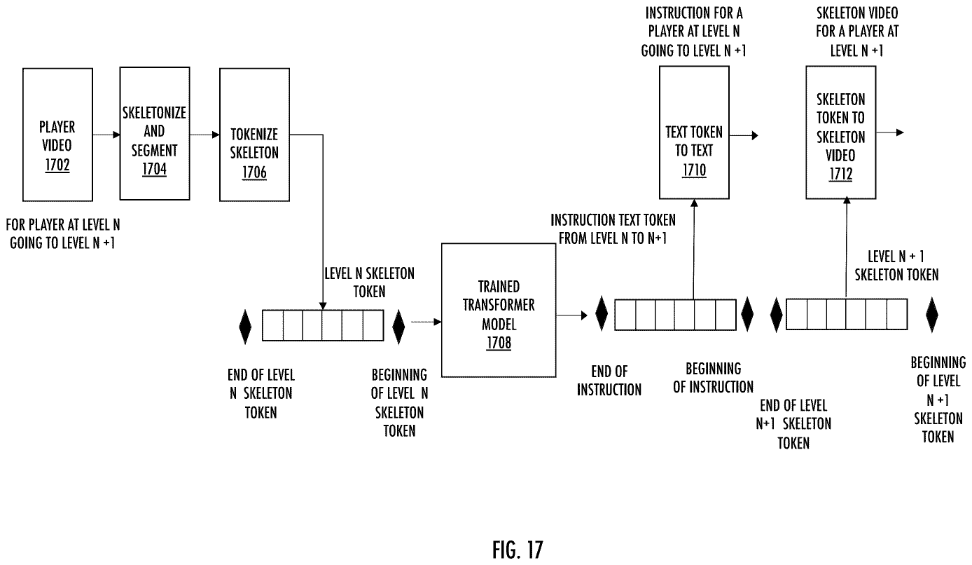

FIG. 17 is a logical block diagram of one implementation of the inference phase for a trained model. The system includes player video 1702, skeletonization and segmentation 1704, tokenization of skeleton 1706, trained transformer model 1708, text token to text 1710, and skeleton token to skeleton video 1712. The figure depicts how a player's recorded video is processed through the trained model to generate multimodal output: (i) textual feedback that provides human-readable technical advice, and (ii) a reconstructed skeleton or video output that visualizes the player's technique at an improved performance level. Together, these outputs enable the model to deliver both prescriptive coaching and demonstrative visualization of optimal technique.

The player video 1702 represents a new input sample provided to the system during the inference phase. The video captures a player performing a specific technique or movement sequence, typically at a pre-defined proficiency level, such as level N. The skeletonization and segmentation 1704 module processes this video using pose estimation and temporal segmentation techniques. The resulting skeletal representation divides the movement into temporally bounded segments corresponding to distinct motion phases. This preprocessing transforms the visual input into a structured, normalized representation of motion suitable for tokenization and subsequent model inference.

The tokenization of skeleton 1706 converts the segmented skeletal frames into a sequential token representation analogous to the tokenization process. Each token corresponds to a quantized motion state, joint configuration, or key feature vector representing a specific frame interval within the skeleton sequence. The resulting stream of skeleton tokens serves as the model input that encodes both spatial and temporal dependencies inherent in the movement. These tokens effectively act as the model's internal “language” for representing player motion.

The trained transformer model 1708 receives the skeleton tokens from 1706 as inference input. Because the model has been pre-trained to associate skeleton and text tokens, it can generate outputs across both modalities. The model produces two distinct output sequences: (i) a skeleton token sequence, which represents the same movement expressed at a higher performance level (for example, converting level N motion into level N+1), and (ii) a text token sequence, which encodes the linguistic advice corresponding to the movement improvement required. These outputs reflect the model's learned mapping between biomechanical transitions and coaching semantics. The transformer's self-attention layers interpret contextual relationships among motion states, enabling it to infer and generate improvements that are biomechanically coherent and contextually relevant.

The text token to text 1710 component converts the model's textual token output into human-readable coaching feedback. Each token sequence is decoded through the model's language head to produce natural-language sentences that describe the specific corrections or enhancements required for the player to progress from level N to level N+1. This advice may include biomechanical guidance (e.g., “increase shoulder rotation before contact”), temporal adjustments (e.g., “initiate weight transfer earlier”), or contextual reinforcement (e.g., “maintain lower stance during recovery”). In some embodiments, this text output may also be converted into audible speech for real-time delivery using a text-to-speech module. The result is an interpretable, personalized explanation of the technical improvements identified by the model.

The skeleton token to skeleton video 1712 component reconstructs a visual output representing the predicted motion at the improved skill level. The skeleton tokens generated by the trained transformer model (1708) are decoded into a sequence of skeletal frames, which may then be reprojected as a skeleton video or composited into a realistic player rendering. This output can display how the player's movement would appear when executed according to higher-level technical criteria. In one embodiment, the model may generate a visualization showing the same player performing at level N+1, providing a tangible demonstration of optimal form. This reconstructed video serves as a direct, visual counterpart to the textual advice output, reinforcing instruction through both descriptive and demonstrative feedback.

The inference process illustrated in FIG. 17 represents the application of the transformer model trained in FIG. 16 to real-world player data. A video of a player at level N is first skeletonized, segmented, and tokenized to form structured input data. These tokens are processed by the trained transformer model 1708 to yield two complementary outputs: a skeleton token stream representing improved technique (level N+1) and a text token stream representing instructional guidance. The skeleton tokens are decoded into a visual motion representation, and the text tokens are decoded into readable or audible coaching advice. Together, these outputs allow the system to produce actionable, multimodal feedback that combines explanation, visualization, and personalization.

The integration of these two output modalities provides a synergistic advantage: the textual output communicates the what and why of improvement, while the visual output illustrates the how. This dual-output inference architecture enables real-time, adaptive coaching systems capable of both analyzing player performance and generating dynamic demonstrations of ideal movement.

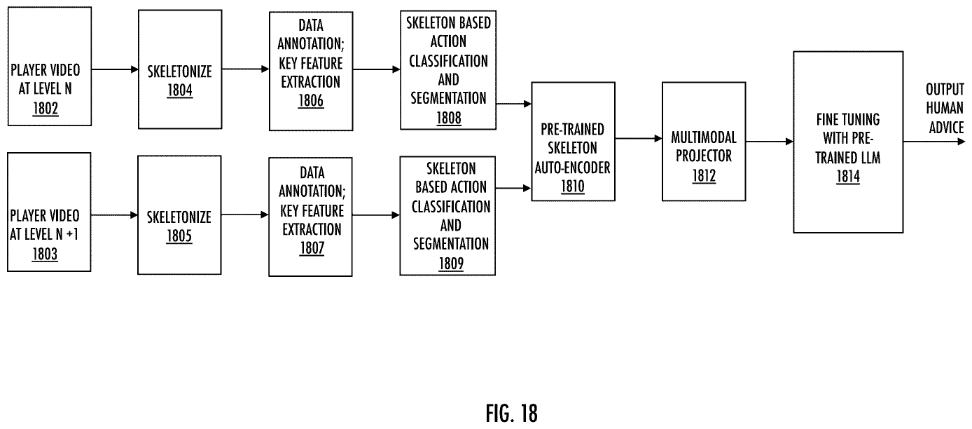

FIG. 18 is a logical block diagram of one method for fine-tuning a pre-trained large language model (LLM). FIG. 18 extends the training and inference architectures above by adding a fine-tuning framework that aligns structured motion data with linguistic representations. The figure includes player video at level N 1802, player video at level N+1 1803, skeletonize at level N 1804, skeletonize at level N+1 1805, data annotation and key feature extraction at level N 1806, data annotation and key feature extraction at level N+1 1807, skeleton-based action classification and segmentation at level N 1808, skeleton-based action classification and segmentation at level N+1 1809, a pre-trained skeleton auto-encoder 1810, a multimodal projector 1812, and a fine-tuning module with pre-trained LLM 1814. The system integrates human-generated coaching data with encoded motion features to adjust the LLM's parameters for contextualized interpretation of biomechanical and instructional information.

The player video at level N 1802 and player video at level N+1 1803 represent two distinct inputs depicting the same or different players performing a given technique at successive proficiency levels. In one embodiment, both videos originate from the same player before and after coaching intervention, while in another, they may represent different players categorized by relative skill levels. These videos provide the raw motion data from which skeletal representations and key features are derived for comparative analysis. The inclusion of paired levels allows the model to learn the relationship between the current state of performance and the desired improvement outcome, establishing a basis for instructional reasoning in the fine-tuning process.

The skeletonize at level N 1804 and skeletonize at level N+1 1805 modules convert the corresponding videos into skeletal representations by detecting joint positions and limb trajectories through pose-estimation algorithms. These skeletal data are then processed through data annotation and key feature extraction at level N 1806 and at level N+1 1807, which label motion segments and extract biomechanical attributes such as angular displacement, timing intervals, and kinetic symmetry. Subsequently, skeleton-based action classification and segmentation at level N 1808 and at level N+1 1809 categorize the motion sequences into defined technique phases—for example, preparation, execution, and recovery. These steps yield structured datasets that represent motion not as raw pixels but as symbolic and quantitative descriptors suitable for embedding into the auto-encoder and multimodal projector.

The pre-trained skeleton auto-encoder 1810 receives the encoded skeleton data and generates a compressed latent representation of each motion sequence. This auto-encoder, pre-trained on large-scale movement data, serves as a feature abstraction mechanism, capturing the essential dynamics and structural patterns of the motion while discarding extraneous noise. The encoded outputs from both level N and level N+1 skeletons are projected into a shared latent space, preserving their temporal and spatial relationships. This latent encoding forms the basis for aligning biomechanical data with linguistic content during multimodal fine-tuning.

The multimodal projector 1812 integrates the encoded skeletal data from the auto-encoder 1810 into a multidimensional embedding space suitable for alignment with language representations. The projector transforms these skeletal embeddings into vectorized forms that are semantically compatible with the embedding dimensions of the pre-trained LLM. This step enables the model to correlate movement-based features with linguistic constructs, bridging the gap between physical motion and textual interpretation. The multimodal projector thereby serves as the translation layer between biomechanical data and natural language understanding, facilitating joint optimization of visual and linguistic parameters during fine-tuning.

The fine-tuning with pre-trained LLM 1814 module performs the adaptation of a pre-trained large language model using the multimodal embeddings produced by the projector 1812. The fine-tuning process employs three primary input sources: (i) the level N skeleton data embeddings representing baseline performance; (ii) the level N+1 embeddings representing target or optimal performance; and (iii) human-generated instructional data describing the transformation between these two states. The human input may include commentary, corrective guidance, training plans, or explanations of technique improvement, provided as text or converted from speech using a speech-to-text system.

During fine-tuning, the LLM's parameters are updated to model the causal and descriptive relationships between physical movement changes and verbal coaching descriptions. The model learns to interpret biomechanical differences as semantic constructs, such as “increase shoulder rotation” or “extend contact follow-through.” The resulting fine-tuned LLM produces human-like responses that contextualize movement corrections, diagnose deficiencies, and generate personalized training advice. This alignment between multimodal data and language allows the model to reason about player performance in both physical and conceptual terms.

The fine-tuning workflow of FIG. 18 proceeds by processing paired player videos from different skill levels through the skeletonization and key-feature extraction pipelines to produce tokenized skeletal data. These representations are encoded by the skeleton auto-encoder 1810 and projected into a multimodal embedding space via the projector 1812. Simultaneously, human commentary describing the improvement process is tokenized and provided as textual input to the LLM. The fine-tuning module 1814 aligns these multimodal inputs, learning cross-domain correspondences between biomechanical feature progression and linguistic instruction.

This process results in a specialized, domain-adapted LLM that can generate descriptive, prescriptive, and diagnostic feedback grounded in movement data. The fine-tuned model can identify problems, propose corrections, develop personalized training plans, and even anticipate injury risks by reasoning over patterns in both skeletal motion and instructional text. As such, the architecture of FIG. 18 establishes a scalable pathway for integrating physical-motion intelligence into transformer-based language models, enabling multimodal reasoning and interactive coaching in future inference systems.

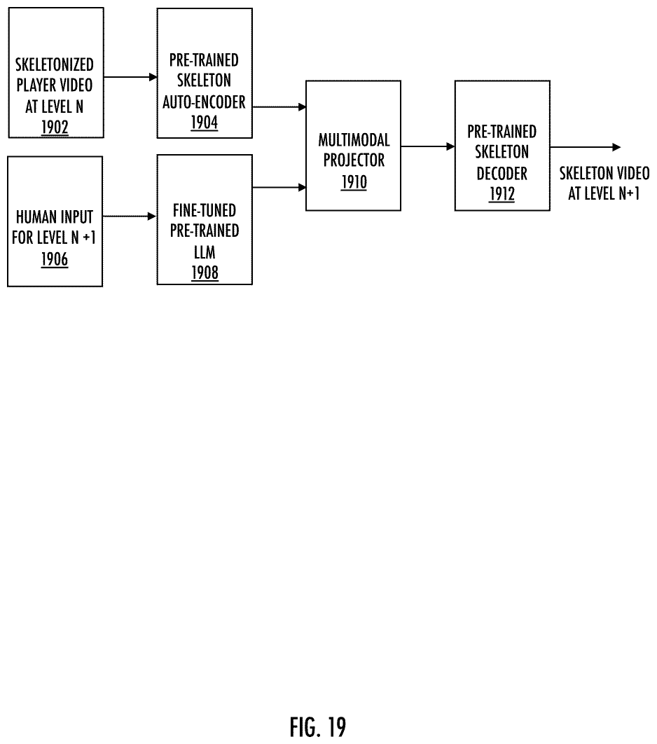

FIG. 19 is a logical block diagram of one implementation of the inference phase for a model that is fine-tuned from a pre-trained large language model (LLM), as shown for example in FIG. 18. The figure includes skeletonized player video at level N 1902, a pre-trained skeleton auto-encoder 1904, human input for level N+1 1906, a fine-tuned pre-trained LLM 1908, a multimodal projector 1910, and a pre-trained skeleton decoder 1912. During inference, skeletal motion data representing a player's current technique are processed in conjunction with human advice describing the next level of improvement. The system projects both inputs into a shared multimodal embedding space and decodes the result into a visual output that demonstrates the player's predicted movement at level N+1.

The skeletonized player video at level N 1902 serves as the primary input to the inference pipeline. The video captures the player performing a given technique at a baseline proficiency level (level N). This video is preprocessed through pose estimation and keypoint extraction, as described elsewhere, to yield a time-series skeleton representation. The pre-trained skeleton auto-encoder 1904 receives this skeletonized data and compresses it into a latent embedding vector that encodes both spatial structure and temporal dynamics of the player's motion. This latent representation preserves critical biomechanical information while reducing data dimensionality, allowing the model to align motion features with semantic guidance provided by the LLM.

The human input for level N+1 1906 provides textual or spoken advice describing how the player's motion should evolve from level N to level N+1. The input may include performance evaluations, corrective suggestions, or detailed technique instructions. This human advice is processed by the fine-tuned pre-trained LLM 1908, which has been adapted through the fine-tuning process described in FIG. 18 to interpret biomechanical and instructional context. The LLM converts the input into a set of linguistic embeddings representing semantic relationships between the desired movement adjustments and the corresponding biomechanical outcomes. These embeddings act as the interpretive bridge between human-language instructions and motion-level representation within the multimodal framework.

The multimodal projector 1910 receives two embedding vectors: (i) the latent motion embedding produced by the pre-trained skeleton auto-encoder 1904, and (ii) the semantic embedding produced by the fine-tuned LLM 1908. The projector aligns these two data modalities within a shared multidimensional feature space. During this process, motion embeddings are spatially and temporally weighted according to the semantic relevance of the coaching advice, allowing the system to integrate how the player currently moves with what the improvement guidance specifies. The resulting fused embedding encapsulates both biomechanical data and linguistic intent, forming the model's internal representation of the player's improved technique.

The pre-trained skeleton decoder 1912 receives the fused multimodal embedding from the projector 1910 and reconstructs a new sequence of skeletal frames representing the player performing the same technique at level N+1. The decoder functions as the generative counterpart to the skeleton auto-encoder, transforming the latent embedding into temporally coherent motion data. The output may be rendered as a skeleton video or recomposed into a full-body animation that visually depicts the improved form. This reconstruction enables the system to provide both descriptive and demonstrative feedback—textual guidance through the LLM and a corresponding visual simulation of the upgraded technique.

The inference process in FIG. 19 begins by converting a player's level N video into a skeletonized representation processed by the auto-encoder 1904. Concurrently, human commentary describing the desired improvement is processed through the fine-tuned LLM 1908. The multimodal projector 1910 merges these two outputs to form an integrated embedding that reflects both biomechanical data and semantic intent. The pre-trained skeleton decoder 1912 then generates a new skeleton sequence depicting the technique executed at level N+1.

This multimodal inference architecture extends the capabilities of traditional motion analysis systems by enabling the model to reason across language and movement domains simultaneously. The resulting output provides both an explanation (why the correction is needed) and a visual demonstration (how the corrected movement should appear). The integration of fine-tuned linguistic and biomechanical embeddings thus allows the system to deliver interpretable, adaptive, and contextually relevant feedback for skill development and performance optimization.

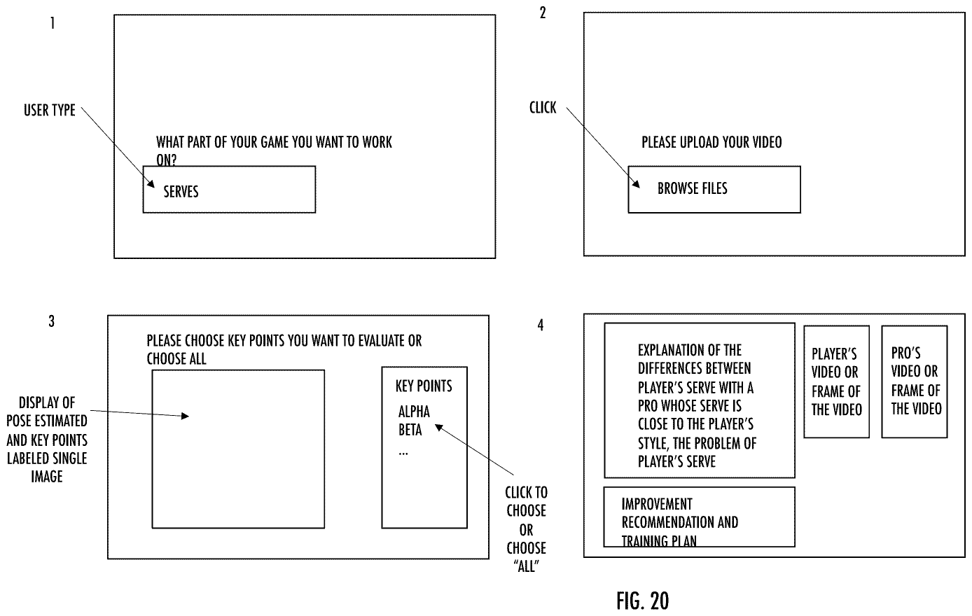

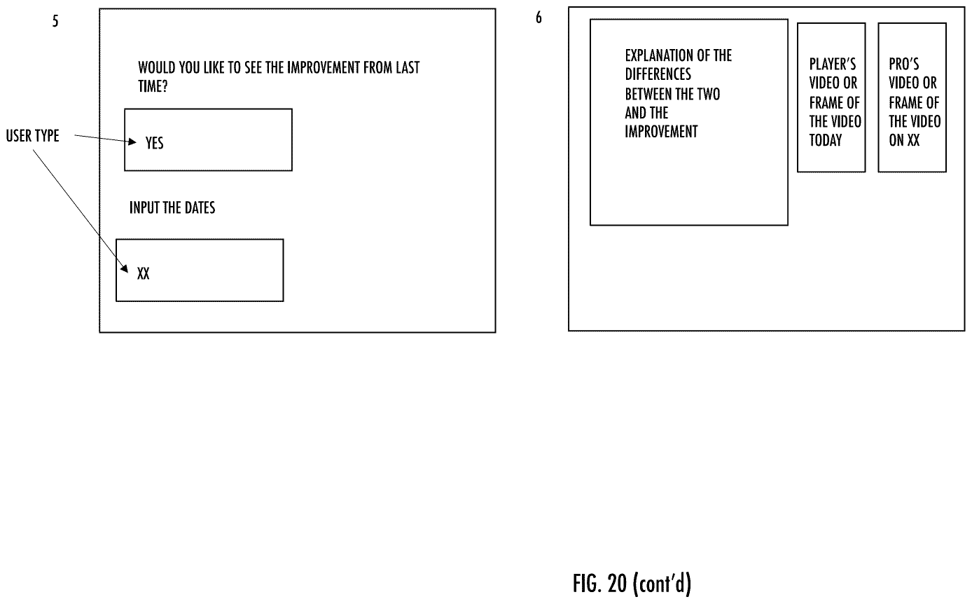

FIG. 20 is a graphical representation of a user interface for a tennis training application. The interface allows users to initiate, control, and interpret AI-generated feedback. Through this interface, a player or coach can upload videos, select comparison targets, define training goals, and request model-generated visual or textual outputs. The UI enables dynamic interaction with the underlying AI system, allowing personalized performance evaluation, simulated motion at higher proficiency levels, and customized instruction for specific tennis techniques such as serves, forehands, backhands, volleys, overheads, and slices.

In one operation, the user—such as a player or a coach—selects training objectives from the user interface. The interface may include selectable fields or icons corresponding to particular training categories, such as learning a new technique, comparing with another player, or improving specific biomechanical features. Upon selection, the interface communicates with the trained model to retrieve or generate the corresponding training outputs. The user may also define the context of the analysis—such as practice, match play, or post-injury recovery—to allow the model to tailor its evaluation criteria accordingly.

In another operation, the user selects a particular tennis technique as the subject of analysis. The application may present a predefined list of options, including serves, forehands, backhands, volleys, overheads, and slices. Once the user selects a technique, the system invokes the corresponding trained AI model to process the user's recorded performance data. The system can then compare the selected technique to reference performances or generate a predicted visualization showing the same technique performed at a higher skill level.

The user may also select specific players from the UI for comparative analysis or emulation. The application may provide a searchable database of professional or reference players whose data are stored in the model's training repository. When a player is selected, the trained model generates side-by-side or overlaid visualizations comparing the user's performance with that of the chosen player. The model highlights similarities and differences in technique execution, tempo, and form, enabling the user to visualize how to modify their own movement patterns to approximate the target player's style or proficiency level.

The interface also allows the user to select key biomechanical features for targeted comparison or improvement. These features may include joint angles, stroke timing, swing plane, or follow-through position. Upon selection, the model identifies corresponding features in both the user's and reference player's performances, then generates a visual overlay or annotated skeleton output illustrating areas of difference. The system may additionally provide descriptive text summarizing how and why these features diverge and what specific corrections are required to improve alignment with the desired standard.

In another operation, the user selects their own prior recordings to compare past and current performances. The system retrieves archived videos, skeletal data, or annotated features from storage and generates a comparative visualization showing progress over time. The user may also specify key features—such as swing speed, balance, or rotation consistency—for detailed evaluation. The system outputs both visual and textual feedback illustrating improvements or persistent discrepancies, enabling longitudinal performance tracking and data-driven coaching.

The user may interact with the application using text, voice, or combined input modes. Voice input may be converted to text using integrated speech-recognition functions, while video or image files of the player's performance can be uploaded directly through the interface. These multimodal inputs are transmitted to the cloud-based inference and processing systems, which execute the selected operations and return synthesized outputs to the user interface. The interface may display textual feedback, reconstructed skeleton videos, or composite renderings that visually demonstrate the user's technique at a higher proficiency level.

The trained model output—such as the skeleton video or the comparative visualization generated from the selected features discussed elsewhere—is displayed within the user interface as an interactive playback module. The user may pause, rewind, or overlay different comparison views, and optionally request new inferences by modifying parameters (e.g., target player, performance level, or technique focus). This interactive feedback loop allows the player or coach to engage in iterative training sessions where model predictions continuously adapt to the user's goals and performance progress. The interface thus functions as a real-time conduit between the human user and the AI-driven multimodal training system, delivering immediate, interpretable, and personalized instruction.

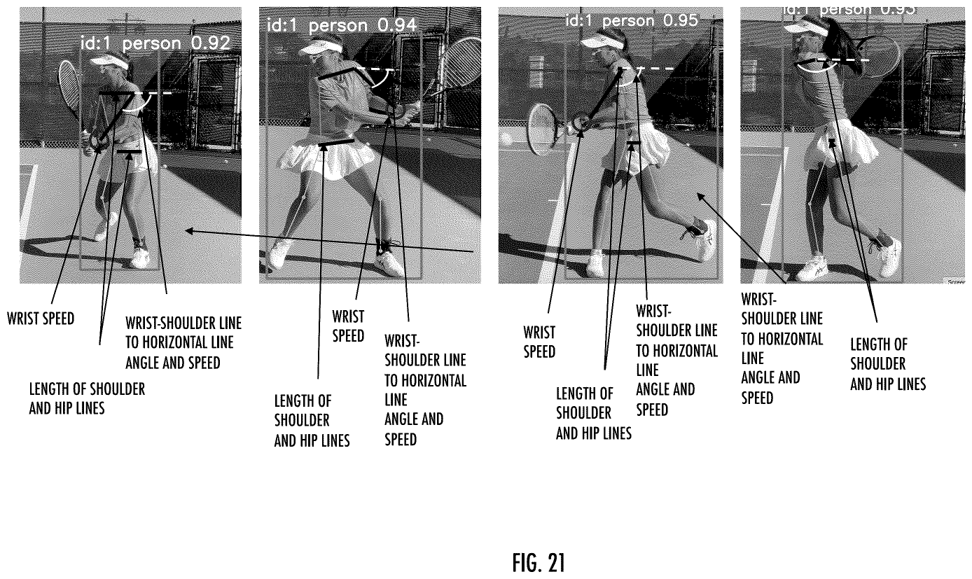

FIG. 21 is a graphical representation of pose estimation and key feature annotation for tennis training of backhand techniques. The figure illustrates how pose-estimation algorithms and human-defined annotations are used to identify and quantify biomechanical characteristics during a player's backhand motion. The illustrated example demonstrates part of the larger data-processing pipeline described above (e.g., FIGS. 1-20), where extracted pose and key feature data are used for both model training and inference. The system allows human experts to define explicit biomechanical features and enables the AI model to learn implicit feature correlations during training, creating a unified foundation for automated coaching and feedback generation.

First, pose estimation is performed on the video or images corresponding to a specific tennis technique—in this example, a backhand stroke. A trained pose-estimation model detects the player's body landmarks, including joints, limbs, and torso orientation, to generate a skeletal representation of the motion. Each frame of the video is analyzed to track joint trajectories, positional coordinates, and angular relationships among body segments. This skeletal data provides a structured foundation from which biomechanical metrics can be derived. The resulting pose sequence serves as the visual-analytic layer that supports human annotation and AI-based feature learning in subsequent operations.

Then, key features of the backhand stroke are explicitly defined by human experts such as coaches or analysts. In the illustrated example, four primary features are identified: (1) the distance between the left and right hips, (2) the distance between the left and right shoulders, (3) the wrist speed, and (4) the angle between the wrist-shoulder line and the horizontal plane, including the rate of change of that angle. These features capture essential biomechanical relationships governing balance, upper-body rotation, and stroke mechanics. Additional or alternative features may be defined to accommodate variations in player form, racket type, or training objectives. For other sports, different sets of key features may be established based on the movement characteristics of the target technique. These human-defined annotations provide labeled ground-truth data for model training and performance evaluation.

In some embodiments, key features are not manually defined but are instead implicitly learned by the AI model during the training phase. The pose estimation outputs—joint coordinates, angular relationships, and motion velocities—are input directly into the model, which learns to infer relevant biomechanical dependencies without explicit labeling. Through exposure to large volumes of annotated and unannotated data, the model develops internal feature representations corresponding to the same biomechanical principles used by human experts. During inference, these implicitly learned features are automatically applied when generating performance analysis or training recommendations. The system thus combines human interpretability with machine-discovered precision, enabling comprehensive and adaptive coaching insights across various skill levels and sports contexts.

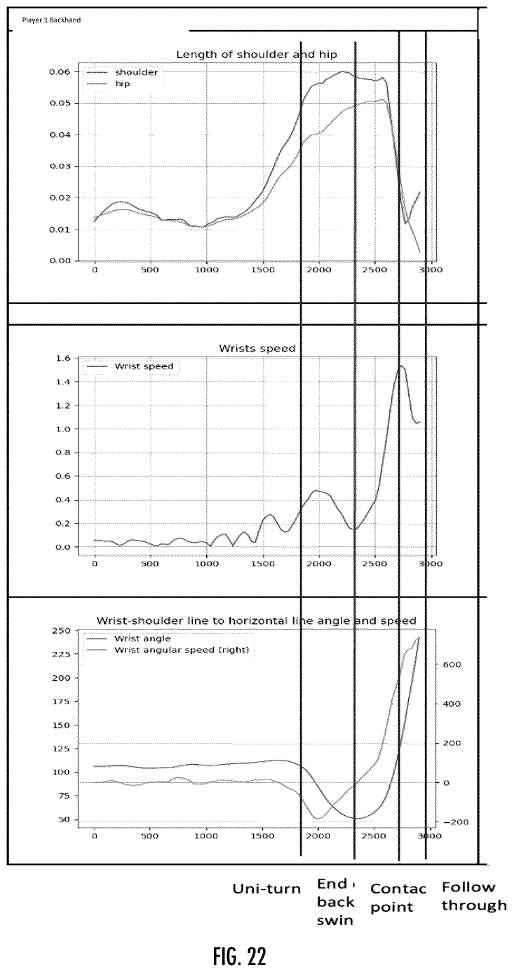

FIG. 22 is a graphical representation of key features extracted from pose estimation after segmentation of the time-series results for tennis training of backhand techniques. This depicts the temporal evolution of quantitative biomechanical parameters derived from sequential video frames. Each curve in the graph represents a computed key feature, such as joint distance, angular velocity, or motion trajectory, measured across the duration of the backhand stroke. The time-series visualization captures the dynamic relationships between features and enables stage-based segmentation for model training, evaluation, and personalized inference.

First, key features are extracted from pose-estimated video sequences of the backhand technique to produce a set of time-series curves. Each curve corresponds to a biomechanical feature identified in FIG. 21, such as wrist speed, hip-shoulder distance, or racket angle. The extracted features are computed frame-by-frame using mathematical and statistical algorithms to quantify motion magnitude and temporal variation. The resulting data are normalized across players and videos to account for recording differences, including perspective, frame rate, and resolution. This normalization ensures that each feature curve is directly comparable, providing consistent input for downstream segmentation and model training operations.

The feature time-series data may be segmented into distinct motion stages representing biomechanical phases of the tennis backhand. The segmentation can be performed either manually by human experts or automatically using algorithmic detection of characteristic inflection points in the curves. In the illustrated example, four segmentation boundaries are defined: (1) unit turn, (2) end of backswing, (3) contact point, and (4) follow-through. Each boundary delineates a biomechanically meaningful phase of motion that corresponds to specific technique components. Additional segmentation lines can be introduced to capture finer-grained transitions depending on user preference or sport-specific requirements. The segmentation process converts continuous time-series data into structured representations that facilitate stage-wise model training and inference.

More broadly, the number and location of motion stages are user-defined. A coach or player may specify the segmentation scheme directly through the user interface described in FIG. 20, allowing the analysis to align with individualized training objectives. Alternatively, automatic segmentation algorithms may infer stage boundaries based on statistical or temporal patterns in the feature data. This flexibility allows the system to adapt to different coaching methodologies or variations in player technique, providing customized and context-aware motion breakdowns.

The segmented time-series curves are used to build datasets for model training. Each segment represents a labeled instance of a technique phase, and the combination of all phases forms a complete temporal profile of the motion. These datasets are used in the supervised and multimodal training processes described elsewhere, where temporal embeddings are learned from pose-derived features and aligned with linguistic inputs from coaching commentary. By training the model on these temporally segmented data, the system learns to associate movement sequences with qualitative coaching descriptions, enabling phase-specific evaluation and correction during inference.

During inference, the same time-series feature curves are generated from a user's performance data and input into the trained model. The model compares the user's feature profiles against reference or idealized profiles from the training database, identifying deviations in amplitude, timing, or rate of change across corresponding motion stages. The system then generates training recommendations based on these detected discrepancies, providing both visual and textual feedback that addresses phase-specific technique refinement. This operation enables precise and interpretable feedback tailored to each player's motion dynamics.

Although the illustrated example of FIG. 21 and FIG. 22 pertains to the tennis backhand, the same methodology can be extended to other sports and movement-based activities. The system architecture and algorithms are applicable to other racket sports such as padel, pickleball, badminton, or squash, and can also be adapted for motion analytics in other sports (e.g., golf, baseball, basketball, soccer, fencing, gymnastics, or swimming, etc.). In each case, the key feature extraction, normalization, segmentation, and time-series modeling processes remain the same, with only sport-specific features or phase definitions adjusted to fit the technique under analysis. This generalization demonstrates the scalability and adaptability of the system for cross-domain athletic and biomechanical applications.

It will be appreciated that the various ones of the foregoing aspects of the present disclosure, or any parts or functions thereof, may be implemented using hardware, software, firmware, tangible, and non-transitory computer-readable or computer usable storage media having instructions stored thereon, or a combination thereof, and may be implemented in one or more computer systems.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. A method of generating personalized skill-specific advice, comprising:
obtaining a first video of a first attempt of a user performing a skill;
extracting a first set of features from the first video;
determining a skill level of the user associated with the first video;
providing the first set of features to an artificial intelligence model trained to generate a first set of skill-specific advice for the user based on the first set of features;
obtaining a second video of a second attempt of the user performing the skill of the first attempt;
extracting a second set of features from the second video; and
providing the second set of features to the artificial intelligence model, where the artificial intelligence model generates a second set of skill-specific advice for the user based on the skill level of the user and the second set of features.

2. The method of claim 1, further comprising organizing the first set of skill-specific advice into first practice exercises for the skill for the user to complete in order to progress from the skill level to a next level.

3. The method of claim 2, where the first practice exercises for the skill are sequentially ordered in time in a personalized progressive pathway for the user.

4. The method of claim 2, where the first practice exercises for the skill are topically arranged into pre-defined categories and aspects.

5. The method of claim 2, further comprising prompting the user to identify completed practice exercises of the first practice exercises for the skill.

6. The method of claim 5, comprising organizing the second set of skill-specific advice into second practice exercises for the skill for the user to complete, where the second practice exercises are based on a progression from the first practice exercises to the completed practice exercises.

7. A method for training an artificial intelligence model to generate output advice, comprising:
obtaining a first set of videos, where each video comprises a person of a skill level attempting to perform a skill; and
for a first video of the first set of videos, the first video associated with a first skill level:
obtaining a first set of human advice from different human coaches for the first video associated with the first skill level;
training the artificial intelligence model to learn first relationships between the first set of human advice for the first video with the first skill level and the first video; and
training the artificial intelligence model to generate the output advice for the first skill level associated with the first video.

8. The method of claim 7, where the method further comprises:
extracting a first set of features from the first video; and
annotating the first set of features based on the first set of human advice for the first skill level.

9. The method of claim 8, where the first set of human advice is at least one of text input, a written document, a voice input, or recorded speech.

10. The method of claim 7, where the first set of videos comprises a plurality of videos associated with a plurality of different skill levels.

11. The method of claim 7, where the first set of human advice comprises a plurality of human advice input associated with the first set of videos.

12. The method of claim 11, where the method further comprises:
for a second video of the first set of videos, the second video associated with a second skill level:
obtaining a second set of human advice from a plurality of human coaches for the second skill level;
training the artificial intelligence model to learn second relationships between the second set of human advice for the second skill level and a the second video; and
training the artificial intelligence model to generate the output advice for the second skill level associated with the second video based on the first relationships and the second relationships.

13. The method of claim 12, where the method further comprises:
extracting a first set of features from the second video; and
annotating the first set of features based on the second set of human advice for the second skill level.

14. The method of claim 13, where the method further comprises:
extracting the first set of features from the first video;
annotating the first set of features based on the first set of human advice for the first skill level;
extracting a second set of features from the second video;
annotating the second set of features based on the second set of human advice for the second skill level; and
where the first set of features and the second set of features have at least one overlapping feature.

15. A method for training an artificial intelligence model based on a pair of videos, comprising:
obtaining a first paired data set comprising:
a first video of a first person attempting to perform a skill and a first human advice input that is associated with the first video and a first skill level, and a second video of a second person attempting to perform the skill and a second human advice input that is associated with the second video and a second skill level; and
training the artificial intelligence model with the first paired data set.

16. The method of claim 15, further comprising:
extracting a first set of features from the first video and a second set of features from the second video; and
annotating the first set of features based on the first human advice input for the first skill level and annotating the second set of features based on the second human advice input for the second skill level.

17. The method of claim 15, further comprising:
extracting a first set of features from the first video and a second set of features from the second video;
representing the first set of features as a first vector within a multi-dimensional vector space; and
representing the second set of features as a second vector within the multi-dimensional vector space.

18. The method of claim 15, where the first skill level and the second skill level are randomly paired.

19. The method of claim 15, further comprising:
assessing the first skill level based on a first vector; and
assessing the second skill level based on a second vector.

20. The method of claim 19, further comprising estimating a first distance between the first vector and the second vector, where the first paired data set is associated with the first distance.

21. The method of claim 20, further comprising training the artificial intelligence model with a second paired data set having a second distance that is within an incremental distance of the first distance.

22. The method of claim 20, further comprising training the artificial intelligence model with a second paired data set having a second distance that is outside an incremental distance of the first distance.

23. A method for training a first artificial intelligence model to generate output advice, comprising:
obtaining a first set of videos, where each video comprises a person of a skill level attempting to perform a skill; and
for a first video of the first set of videos, the first video associated with a first skill level:
obtaining a first set of text advice from a second artificial intelligence model different than the first artificial intelligence model, the first set of text advice associated with the first video associated with the first skill level;
training the first artificial intelligence model to learn first relationships between the first set of text advice for the first video with the first skill level and the first video; and
training the first artificial intelligence model to generate the output advice for the first skill level associated with the first video.
